(19) United States
(12) Patent Application Publication
(10) Pub. No.: US 2026/0317092 A1
(43) Pub. Date: Oct. 15, 2026

(54) SYSTEMS AND METHODS OF UNLOADING AND DELIVERING PROPPANT FOR A WELL TREATMENT FLUID BLENDER

(71) Applicant: Halliburton Energy Services, Inc., Houston, TX (US)

(72) Inventors: Bryan C. Lucas, Duncan, OK (US); Cameron Michael Kramer, Duncan, OK (US)

(21) Appl. No.: 19/179,266

(22) Filed: Apr. 15, 2025

(51) Int. Cl. B65G 63/00; B65G 41/00; B65G 67/24; E21B 43/26

(52) U.S. Cl. CPC B65G 63/008; B65G 41/005; B65G 67/24; E21B 43/2607; B65G 2201/042

(57) ABSTRACT

Systems and methods for efficiently managing bulk material at a wellsite are provided. For example, a proppant delivery system may comprise an unloading conveyor, a delivery unit, and one or more refill station configured to hold an empty buffer container. In embodiments, the delivery unit can comprise a surge hopper configured to hold proppant, one or more support structure, each configured to support a portable buffer container, and a delivery conveyor configured to feed proppant from the surge hopper and/or the one or more buffer container to an inlet of the blender. Typically, each support structures can be configured to hold the corresponding buffer container above the delivery conveyor. In embodiments, the unloading conveyor can be configured to receive proppant from a belly-dump truck and to transport the proppant therefrom, and the proppant from the belly-dump truck can be selectively transported to the surge hopper and/or refill station.

### CROSS REFERENCE TO RELATED APPLICATIONS

None.

STATEMENT REGARDING FEDERALLY SPONSORED RESEARCH OR DEVELOPMENT

Not applicable.

### TECHNICAL FIELD

The present disclosure relates generally to transferring dry bulk materials, and more particularly, to improved systems and methods for unloading and delivering proppant to a well treatment fluid blender.

### BACKGROUND

During the drilling and completion of oil and gas wells, various wellbore treating fluids are used for a number of purposes. For example, high viscosity gels are used to create fractures in oil and gas bearing formations to increase production. High viscosity and high density gels are also used to maintain positive hydrostatic pressure in the well while limiting flow of well fluids into earth formations during installation of completion equipment. High viscosity fluids are used to flow sand into wells during gravel packing operations. The high viscosity fluids are normally produced by mixing dry powder and/or granular materials and agents with water at the well site as they are needed for the particular treatment. Systems for metering and mixing the various materials are normally portable, e.g., skid-or truck-mounted, since they are needed for only short periods of time at a well site.

The powder or granular treating material may normally be transported to a well site in a commercial or common carrier tank truck. Once the tank truck and mixing system are at the well site, the dry powder material (bulk material) typically is transferred or conveyed from the conventional tank truck into a supply tank for metering into a blender as needed. For example, the bulk material can usually be transferred from the tank truck pneumatically. More specifically, the bulk material can be blown pneumatically from the tank truck into an on-location storage/delivery system (e.g., silo). The storage/delivery system may then deliver the bulk material onto a conveyor or into a hopper, which meters the bulk material through a chute into a blender tub.

More recently, bulk material handling operations may alternatively involve the use of portable containers for transporting dry material about a well location. The containers can be brought in on trucks, unloaded, stored on location, and manipulated about the well site when the material is needed. The containers may generally be easier to manipulate on location than a large supply tank trailer. The containers are eventually emptied by dumping the contents thereof onto a mechanical conveying system (e.g., conveyor belt, auger, bucket lift, etc.). The conveying system then moves the bulk material in a metered fashion to a desired destination at the well site.

### BRIEF DESCRIPTION OF THE DRAWINGS

For a more complete understanding of the present disclosure and its features and advantages, reference is now made to the following description, taken in conjunction with the accompanying drawings, wherein like reference numerals represent like parts, in which:

FIG. 1 is a schematic diagram of an exemplary bulk material handling system, in accordance with an embodiment of the present disclosure;

FIG. 2 is a schematic diagram of another embodiment of an exemplary bulk material handling system, in accordance with an embodiment of the present disclosure;

FIG. 3 is a schematic diagram of yet another embodiment of an exemplary bulk material handling system, in accordance with an embodiment of the present disclosure;

FIG. 4 is a schematic diagram of still another embodiment of an exemplary bulk material handling system, in accordance with an embodiment of the present disclosure;

FIG. 5 is a schematic diagram of yet another embodiment of an exemplary bulk material handling system, in accordance with an embodiment of the present disclosure;

FIG. 6 is a schematic diagram of a modification for a bulk material handling system (e.g. for a system similar to that of FIG. 1, but with telescoping to allow for discharge of proppant along concentric radial arcs), in accordance with an embodiment of the present disclosure;

FIG. 7 is a schematic diagram of still another embodiment of an exemplary bulk material handling system, in accordance with an embodiment of the present disclosure;

FIG. 8 illustrates an exemplary belly-dump truck, of the sort that may be used in one or more disclosed system embodiment, in accordance with an embodiment of the present disclosure;

FIG. 9 illustrates an exemplary receiving end of an exemplary unloading conveyor (e.g. having a ramp), of the sort that may be used in one or more disclosed system embodiment, in accordance with an embodiment of the present disclosure;

FIG. 10 illustrates an exemplary unloading conveyor, of the sort that may be used in one or more disclosed system embodiment, in accordance with an embodiment of the present disclosure;

FIG. 11 illustrates an exemplary delivery conveyor and its interaction with an exemplary surge hopper of an exemplary delivery unit, of the sort that may be used in one or more disclosed system embodiment, in accordance with an embodiment of the present disclosure;

FIG. 12 illustrates an exemplary surge hopper of an exemplary delivery unit, of the sort that may be used in one or more disclosed system embodiment, in accordance with an embodiment of the present disclosure;

FIG. 13 illustrates an exemplary supporting structure (e.g. stand) on an exemplary delivery unit which is configured to hold a container of bulk material for discharge onto a delivery conveyor, in accordance with an embodiment of the present disclosure;

FIG. 14 illustrates an exemplary unloading conveyor, for example with interaction between an exemplary offload portion and an exemplary radial portion, of the sort that may be used in one or more disclosed system embodiment, in accordance with an embodiment of the present disclosure;

FIG. 15 illustrates an exemplary refill station, of the sort that may be used in one or more disclosed system embodiment, in accordance with an embodiment of the present disclosure;

FIG. 16 illustrates an exemplary container, of the sort that may be used in one or more disclosed system embodiment, in accordance with an embodiment of the present disclosure;

FIG. 17 is a schematic diagram of an exemplary system for providing well treatment fluids to a well, in accordance with an embodiment of the present disclosure; and

FIG. 18 is a schematic diagram of an alternate embodiment of a delivery unit of the sort that may be used in an exemplary bulk material handling system (e.g. similar to FIG. 1), in accordance with an embodiment of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers'specific goals, such as compliance with system related and business-related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

Certain embodiments according to the present disclosure may be directed to systems and methods for efficiently managing bulk material (e.g., bulk solid or liquid material, including proppant such as sand). Bulk material handling systems are used in a wide variety of contexts including, but not limited to, drilling and completion of oil and gas wells, concrete mixing applications, agriculture, and others. The disclosed embodiments are directed to systems and methods for efficiently moving bulk material into a blender inlet of a blender unit at a job site. The disclosed systems may include mechanisms to unload proppant from a proppant transport vehicle (e.g. such as a belly-dump truck, end-dump truck, or side-dump truck), mechanisms to move unloaded proppant from a surge hopper to the blender inlet, and methods to address bulk material in excess of the surge hopper capacity and/or instances when the surge hopper empties but continuous supply of proppant is still desired.

For example, systems may comprise an unloading conveyor and a delivery unit as described herein, and may employ a combination of continuous feed of proppant (e.g. using the delivery unit) in conjunction with portable containers (e.g. which may be used for management of excess or insufficient proppant available at the delivery unit). In some embodiments, portable containers may only be used to address such proppant management situations (e.g. with the preferred/primary mechanism for providing proppant to the blender being unloading of the belly-dump truck to the surge hopper of the delivery unit, and delivery of proppant from the surge hopper to the blender). The disclosed techniques may be used to efficiently handle any desirable bulk material having a solid or liquid constituency including, but not limited to, sand, proppant, gel particulate, diverting agent, dry-gel particulate, liquid additives and others, and while typically discussed herein with respect to proppant, are not so limited.

In on-site bulk material handling applications, dry material (e.g., sand, proppant, gel particulate, or dry-gel particulate) may be used during the formation of treatment fluids for a well (such as a hydrocarbon well). In such applications, the bulk material conventionally is often transferred between transportation units, storage tanks, blenders, and other on-site components via pneumatic transfer, sand screws, chutes, conveyor belts, and/or other components. The present disclosure is directed to improved systems and methods for delivering bulk materials (such as proppant) to a blender at a wellsite (e.g. for preparation and delivery of well treatment fluid to the well).

By way of general, non-limiting example, the system may include: (1) belly-dump truck unloading equipment (e.g. which can involve 1 or 2 conveyors, configured to move proppant from the belly-dump truck or other proppant transport vehicle to a delivery unit), (2) a delivery unit (e.g. a mobile delivery trailer which can include an integrated surge hopper (e.g. configured to be the primary proppant supply for the blender) and a delivery conveyor (e.g. configured to feed proppant from the surge hopper to the blender), along with positions (e.g. support structures) for at least one (e.g. typically two) containers (e.g. configured to provide proppant to the delivery conveyor in the event that the surge hopper empties, for example to maintain substantially continuous flow of proppant to the blender), and (3) a refilling station (e.g. one or more stations configured to hold an empty container for refill, for example from the belly-dump truck). For example, the refill station(s) may be used to handle amounts of proppant from the belly-dump truck that are in excess of the capacity of the surge hopper.

Filled containers (e.g. from the refill station and/or otherwise stored on site) may be used on the support structures of the delivery unit as described above (e.g. to provide proppant in the event that the surge hopper runs empty). In this way, the containers (e.g. in conjunction with use of the refill station(s) and the support structure(s)) can be used to better manage proppant supply, allowing for storage of oversupply from the belly-dump truck (e.g. in excess of the capacity of the surge hopper) and/or allowing for substantially continuous supply of proppant to the blender even when the surge hopper empties (e.g. due to trucking delays). If proppant supply (e.g. belly-dump truck scheduling) can be precisely matched to blender needs, then the containers may not be needed (and for example, forklift operations may be unnecessary), but in the event that scheduling varies during real-world conditions, the container(s) can be used to help address situations of oversupply and/or undersupply by the belly-dump truck (e.g. smoothing out scheduling issues in an efficient manner to maximize substantially continuous blender production of well treatment fluid).

In some embodiments, the unloading conveyor can include one or more conveyors (e.g. one or more radial belts). The unloading conveyor may be configured to travel to multiple positions on location/site, including the primary station (e.g. the surge hopper on the delivery unit configured to directly feed the blender inlet via the delivery conveyor), as well as a secondary refilling station. For example, the discharge end of the unloading conveyor may be moveable between the primary and secondary stations. The default offload discharge location may be into the surge hopper. In the event that the surge hopper is full and empty containers are available, the discharge end of the unloading conveyor can move (e.g. by radial positioning and/or telescoping extension) and fill empty containers at the secondary/refill station (and in some embodiments, the secondary station may include two or more refill stations, allowing for more than one container to be refilled, for example if the excess proppant exceeds the capacity of one container). On the other hand, in the event that truck deliveries from the mine (e.g. supplying proppant) fall behind and the surge hopper runs empty, full containers held on location can be used (e.g. by being placed on the support structures of the delivery unit to allow for discharge of their proppant onto the delivery conveyor) to supply proppant to the blender (e.g. to provide substantially continuous proppant supply and allow for continued well production).

Typically, two such full containers may be held at the ready on the delivery unit (e.g. on the support structures), so that the proppant supply source may be changed without significant delay (e.g. to provide substantially continuous proppant feed). Often, the unloading conveyor may have a fixed length (e.g. with rotation along a radial arc providing the movement between stations), but in some embodiments a telescoping unloading conveyor may be used, for example to allow for alternate or more complex site layouts. In some embodiments, the delivery conveyor may be used to meter the proppant into the blender. In some embodiments, the blender inlet/hopper may provide metering. In some embodiments, a number of full containers may be kept on hand (e.g. at a buffer storage station), to ensure proppant supply is available onsite in the event of trucking delays. To maximize efficiency, automation can be incorporated to seamlessly move the unloading conveyor from the primary/default station to the secondary/refill station and/or to alert operators if the primary/surge hopper is full or nearing empty (in which instance forklift operations may need to be utilized for movement of containers). In some embodiments, the switching of proppant delivery between stations may be provided in alternate ways, including options that do not require movement of the discharge end of the unloading conveyor, and all such embodiments are included within the scope herein. More detailed examples are provided below with respect to the figures, and persons of skill will understand that combinations and/or variations (e.g. within ordinary skill) are included within the scope of this disclosure.

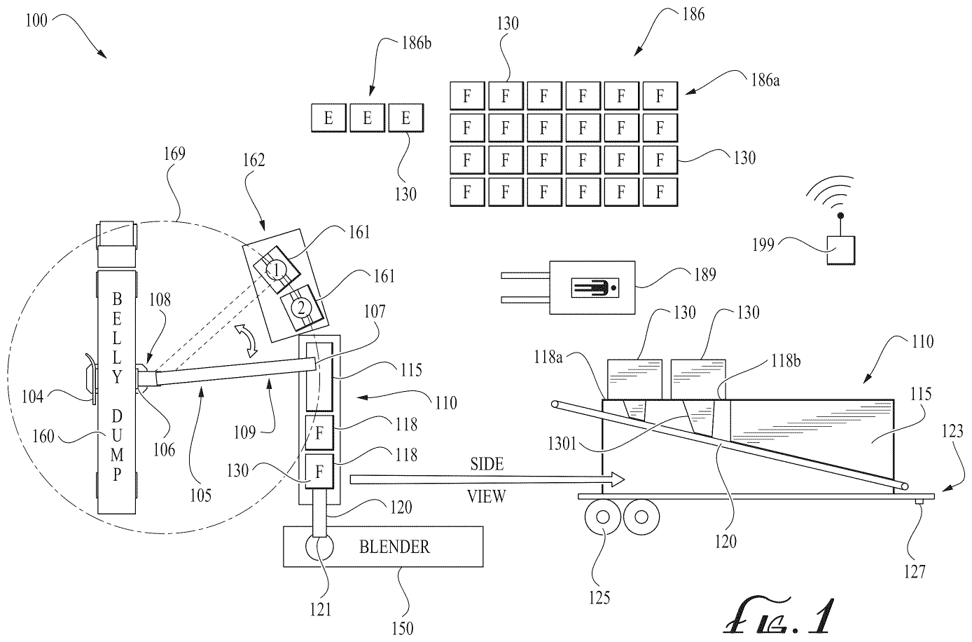

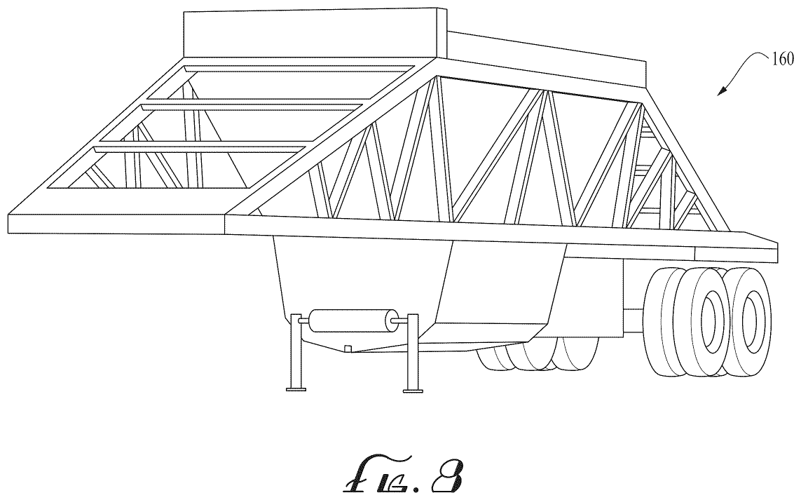

FIG. 1 illustrates an exemplary proppant delivery system 100, showing an embodiment using radial rotation/pivoting of the unloading conveyor to move between stations. The proppant delivery system 100 can be configured to provide proppant to a blender 150 for well services (e.g. with the blender forming well treatment fluid, such as fracturing fluid, for delivery to the wellbore). In FIG. 1, the system 100 comprises an unloading conveyor 105 (e.g. one or more moving belt), a delivery unit 110, and a secondary station 162 (e.g. having one or more refill stations 161). The delivery unit 110 of FIG. 1 comprises a surge hopper 115 (e.g. configured to hold proppant); one or more (e.g. two or more) support structures 118, each configured to support a portable (e.g. separate) buffer container 130 (e.g. holding proppant); and a delivery conveyor 120 (e.g. a moving belt) configured to transport/feed proppant from the surge hopper 115 and/or buffer containers 130 (e.g. disposed on the support structures 118) to a blender 150 (e.g. via an inlet/hopper). The support structures 118 of FIG. 1 are configured to hold corresponding buffer containers 130 above the delivery conveyor 120 (e.g. with their discharge gates located above the delivery conveyor so that when open, proppant in the container is gravity fed onto the delivery conveyor). As shown in FIG. 1, the unloading conveyor 105 can be configured to receive proppant (e.g. dropped via gravity feed) from a belly-dump truck 160 (see for example FIG. 8, illustrating an exemplary belly-dump truck, although it should be understood that any usage of belly-dump truck is exemplary and is intended to include all proppant transport vehicle embodiments, such as end-dump trucks, side-dump trucks, and similar trailers configured to be pulled by a conventional truck) and to transport the proppant to the delivery unit 110 (e.g. to the surge hopper 115 and/or at the primary station). The system 100 may be configured so that proppant from the belly-dump truck 160 can be selectively/alternatively/switchably transported to the surge hopper 115 and/or the secondary station 162 (e.g. to one or more refill station 161).

Typically, the surge hopper 115 is not a silo. For example, the surge hopper 115 typically may be lower (e.g. have less height), mobile (e.g. mounted on the mobile delivery unit 110, for example rather than being separate and/or fixed at the site), have a smaller volume, and/or have an open top compared to a typical/conventional silo. For example, the surge hopper 115 may extend no more than 20 (or 15 or 10 in some embodiments) feet above the surface/ground, and/or the surge hopper 115 may have a volume greater than a single container-for example a volume of approximately 2-5 containers (e.g. 2-3 containers)-but less than approximately five or seven containers (e.g. significantly less than a conventional silo, which may hold the equivalent of 7-10 containers).

In some embodiments, the unloading conveyor 105 can comprise a receiving end 106, for example configured to be positioned under the belly-dump truck 160 (e.g. with a height sufficiently low to fit beneath the belly-dump truck and/or configured to contain the dumped proppant), and a discharge end 107 configured to discharge proppant (e.g. into the surge hopper of the delivery unit and/or into empty buffer containers (e.g. at the refill station) and/or directly into the blender hopper/inlet, depending on the specific system requirements). Typically, the discharge end 107 may be configured to be elevated at a height greater than the receiving end 106. For example, the receiving end 106 may be disposed at a height in proximity to the ground/surface (e.g. so that it fits below the belly-dump truck, for example no more than 48 inches, approximately 24-48 inches, or approximately 36 inches above the ground) and the discharge end 107 may be configured to be no more than 20 (or 15 or 10 in some embodiments) feet above the surface/ground (e.g. configured to feed into the top of the surge hopper). In some embodiments, the height of the discharge end 107 may be adjustable (e.g. when moving between stations).

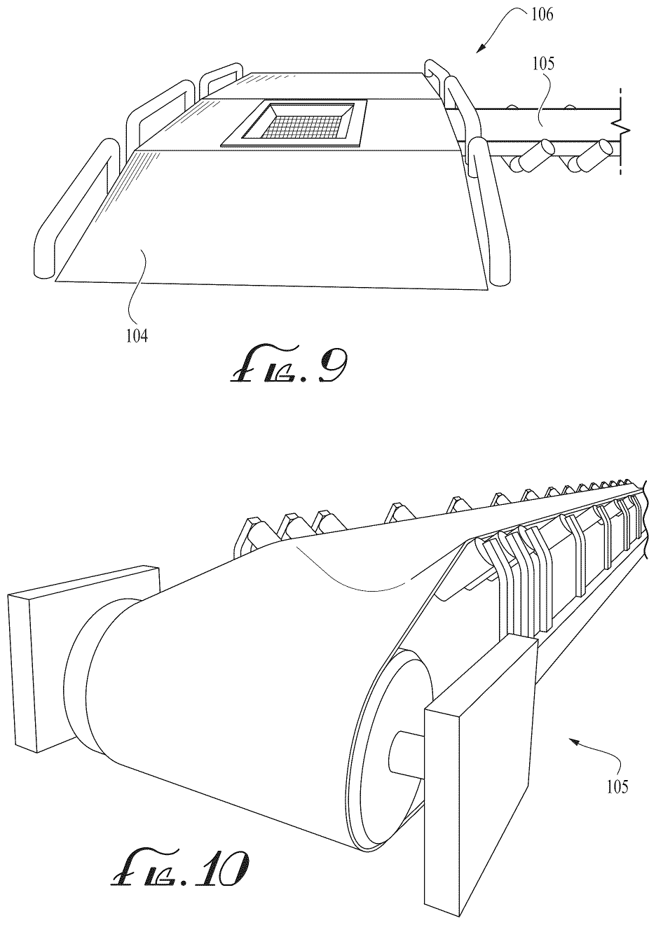

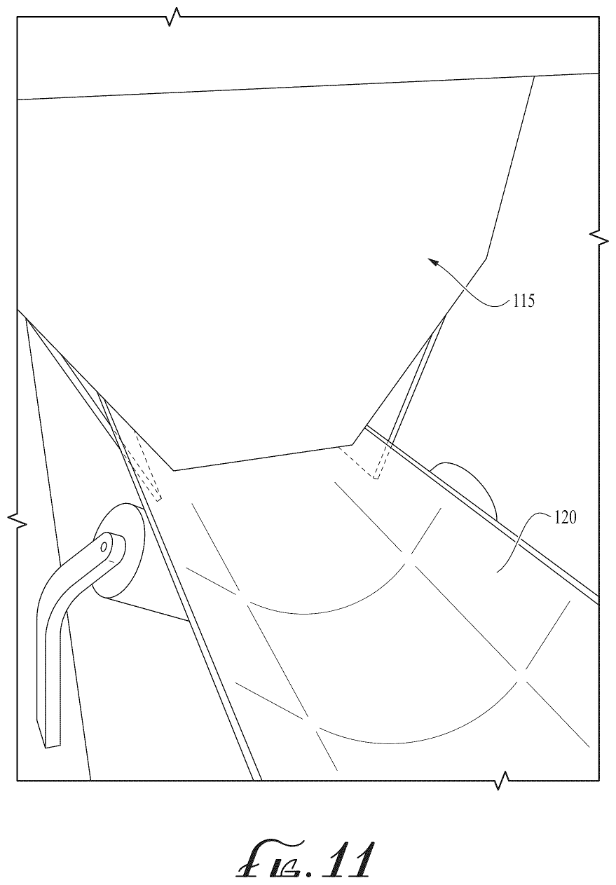

In some embodiments, the unloading conveyor 105 can further comprise one or more ramps 104 configured to allow the belly-dump truck 160 to drive over the receiving end 106 of the unloading conveyor 105 (e.g. without damaging the unloading conveyor) for positioning for gravity dump of proppant onto the receiving end 106. FIG. 9 illustrates an exemplary ramp 104, for example having two inclined planes with a discharge opening therebetween. This may allow the clamshell gate of the belly-dump truck 160 to be positioned over the receiving end 106 for gravity discharge thereto. Typically, the unloading conveyor 105 can be separate and apart from the delivery unit 110 and/or the belly-dump truck 160. In some embodiments, the unloading conveyor 105 can be curved (e.g. across its width, so that its side edges are elevated above its central portion-see for example FIG. 10), to help retain proppant therein (e.g. to keep proppant from falling off the side edges). In some embodiments, the unloading conveyor 105 can be configured to operate faster than the delivery conveyor 120.

In some embodiments, the delivery unit 110 can be configured to be transportable/mobile. For example, the delivery unit 110 may be a delivery trailer having a trailer 123 with wheels 125 and a hitch 127 for attachment to a transport truck. As shown in FIG. 1, the delivery conveyor 120 can be disposed below the surge hopper 115 and the containers 130 (e.g. on the support structures 118) and can be configured to receive proppant therefrom. The delivery conveyor 120 is configured to feed proppant to the blender inlet/hopper and/or to meter the proppant into the blender 150 (e.g. the delivery conveyor may have variable speed). In FIG. 1, the delivery conveyor 120 comprises a blender feed end 121 (e.g. configured to be disposed over the blender inlet/hopper, for example to allow for gravity feeding of proppant from the delivery conveyor 120 into the blender 150). In some embodiments, the delivery conveyor 120 can form the floor/bottom of the surge hopper 115. As shown in FIG. 1, in some embodiments the delivery conveyor 120 can angle upward (e.g. from the surge hopper 115 and/or rear of the delivery unit) towards the blender feed end 121.

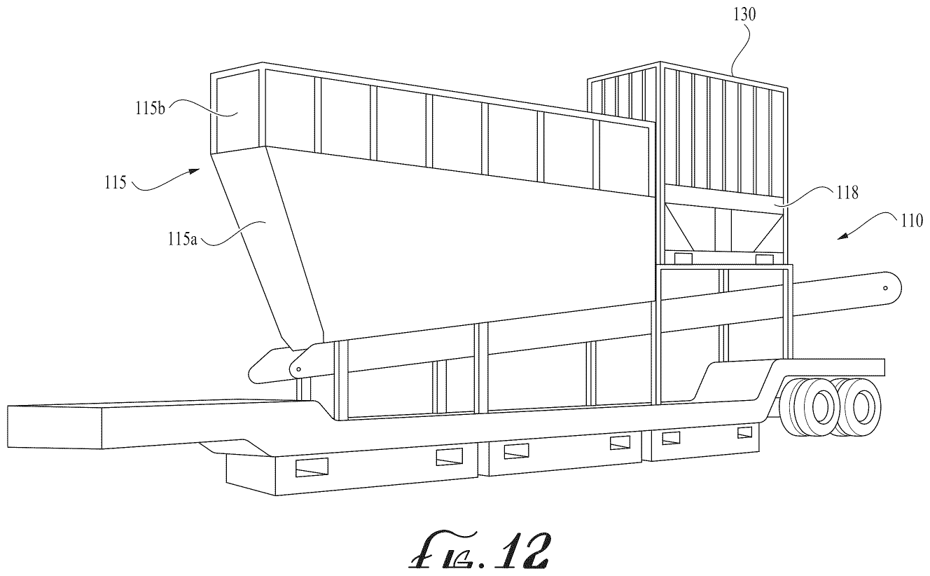

While the delivery conveyor 120 of FIG. 1 is shown as a single angled conveyor, in some embodiments the delivery conveyor 120 can comprise two conveyors 120a and 120b, which may be configured to jointly move proppant from the surge hopper 115 to the blender. For example, a first conveyor 120a (e.g. which can form the floor of the surge hopper 115 in some embodiments and/or can be disposed in proximity to the bottom of the delivery unit 110) can be substantially horizontal (e.g. to maximize the volume of the surge hopper 115 on the delivery unit 110), and the second conveyor 120b can extend/angle upward from the first conveyor 120a (e.g. in proximity to the front of the surge hopper 115) to discharge into the blender inlet (e.g. in proximity to the top of the delivery unit 110). FIG. 18 illustrates such an exemplary embodiment. In some embodiments, rather than two conveyors, the delivery conveyor 120 can comprise a single bent conveyor (e.g. with a bend in proximity to the front of the surge hopper 115) that can function similarly (e.g. with a first portion extending approximately horizontally in proximity to the bottom of the surge hopper and/or forming the bottom/floor of the surge hopper, and a second portion angling upward (e.g. from proximity to the front of the surge hopper) to the blender inlet (e.g. in proximity to the top of the delivery unit)). In some embodiments, the delivery conveyor can be curved (e.g. across its width, so that its side edges are elevated above its central portion—see for example FIG. 11), to help retain proppant therein (e.g. to keep proppant from falling off the side edges).

Surge hopper 115 embodiments may further comprise a back, two sides, a front, and an open top (e.g. in addition to the floor/bottom formed by the delivery conveyor 120). For example, the back and two sides can extend upward from the delivery conveyor 120 (e.g. to enclose the delivery conveyor), and the front may not contact the delivery conveyor 120 (e.g. leaving an opening/gap at the bottom in the front of the surge hopper 115 allowing proppant therein to be carried out by the delivery conveyor 120—see for example FIG. 11). In some embodiments, the sides of the surge hopper 115 can be angled inward towards the bottom (e.g. to funnel proppant to the delivery conveyor). In some embodiments, the front can be configured to allow for adjustment of the opening/gap (e.g. the height/size of the opening can be adjustable), for example to help control the rate of proppant delivery.

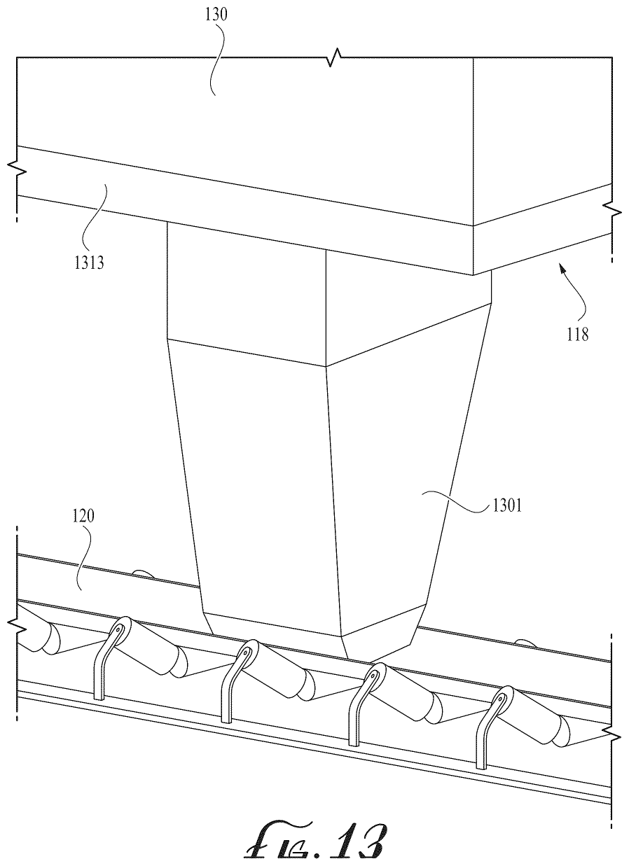

As shown in FIG. 12, some embodiments of the surge hopper 115 can comprise a primary hopper 115a permanently mounted in place with respect to the delivery conveyor 120 and a removable height/extension portion/sheath 115b configured to removably couple (e.g. after transport of the delivery unit to the site) atop the primary hopper 115a to extend the height/volume of the surge hopper 115. Typically, the open top of the surge hopper 115 is disposed no more than 20 feet (or 15 feet or 10 feet in different embodiments) above the ground/surface and/or receiving end 106 of the unloading conveyor 105. In some embodiments, the top of the primary hopper 115 a may be no more than 20 feet (or 15 feet or 10 feet) above the ground/surface and/or receiving end of the unloading conveyor, and the extension portion 115 b may extend additional height (e.g. up to approximately 30 feet). In other embodiments, the entire surge hopper 115 (e.g. including the extension portion 115b) may be no more than 20 feet (or 15 feet or 10 feet) above the ground/surface and/or receiving end 106 of the unloading conveyor 105.

Typically, the surge hopper 115 may have a volume greater than a single container 130. For example, the surge hopper 115 may have a volume of approximately 2-5 containers (e.g. 2-3 containers). In some embodiments, the surge hopper 115 may have a volume no less than that of the belly-dump truck 160 (and typically each container 130 may have a volume less than the belly-dump truck 160, for example requiring 2-3 containers to hold the entire volume of the belly-dump truck). Typically, the surge hopper 115 can be integral to the delivery unit 110 (e.g. to a trailer 123 on which the elements of the delivery unit are fixed/mounted).

In some embodiments, one or more sensor may be integrated into the delivery unit 115 to allow for determination of fill level for surge hopper 115 and/or containers 130 on the support structures 118. Typically, the delivery conveyor 120, surge hopper 115, and support structures 118 are mounted on a trailer 123 (e.g. the surge hopper, delivery conveyor, and support structures are integral to the trailer—e.g. not removable, but fixed). Having the support structure 118, delivery conveyor 120, and surge hopper 115 integrated into a separate mobile unit (e.g. trailer/delivery unit 110) may improve the reliability of the various components and increase the life of the unit. This is because every time elements are lifted or moved via a hoisting mechanism, for example, the integrity, electronics, controls, and/or outlets can be negatively impacted. Shock from movement of the elements can be minimized using integration. In some embodiments, the delivery unit 110 may also include an air suspension system or other components to reduce shock on the delivery unit 110 during transportation (e.g., traveling along a road). The suspension system may help to further isolate the electronics, sensors, and controls of from shock loading during transportation along the road.

In some embodiments, the support structures 118 can be disposed in proximity to the blender feed end 121 of the delivery conveyor 120 (e.g. located between the blender feed end 121 of the delivery conveyor and the surge hopper 115). For example, the surge hopper 115 of FIG. 1 is disposed distal to the blender feed end 121 of the delivery conveyor 120, and the two support structures 118 are disposed serially therebetween (e.g. so that a first support 118a structure is disposed in proximity to the front of the delivery unit 110 and/or to the blender feed end 121 of the delivery conveyor 120, the surge hopper 115 is disposed distal to the front end and/or blender feed end 121, and the second support structure 118b is disposed between the first support structure 118a and the surge hopper 115 (e.g. with the delivery conveyor 120 running beneath them all).

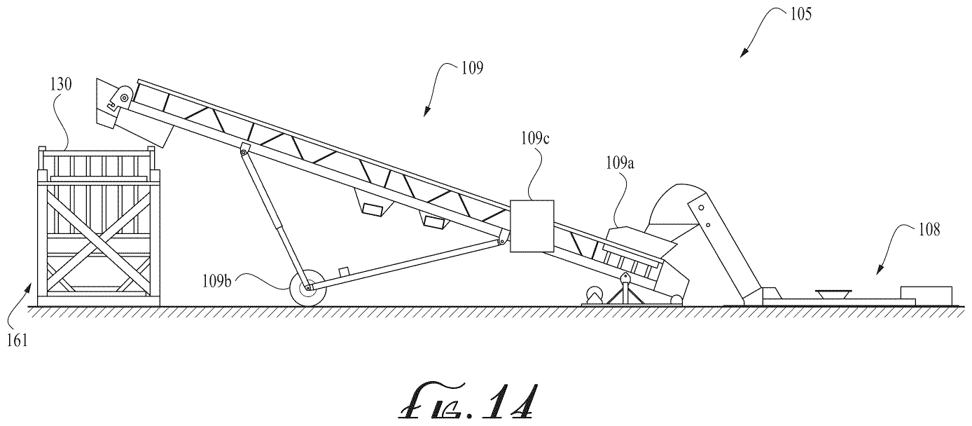

In some embodiments, each support structure 118 may include a support stand/frame configured to hold the corresponding container 130 above the delivery conveyor 120, and some embodiments may include one or more locator (e.g. disposed on the upper surface of the stand to help position the container thereon, for example mating with corresponding elements on the bottom of the container 130) and/or one or more sensor (e.g. configured to detect the presence of the container on the stand and/or the fill-level (e.g. amount of proppant) in the container). For example, each support structure 118 can generally support a corresponding (e.g. full) container 130 above the delivery conveyor 120 (e.g., moving belt, auger, bucket lift, etc.) prior to release of the bulk material (e.g. proppant). Each support structure 118 may include a frame 1313 for receiving and holding a corresponding one of the portable bulk material containers 130 in an elevated position above the delivery conveyor 120. The support structure frame typically comprises an opening (e.g. centrally located) through which a discharge gate of the container may extend and/or through which dispensed bulk material may be gravity fed. The frame may be formed of beam elements, for example forming a rectangular upper surface that substantially matches the size and shape of the bottom surface of the container 130. The discharge gate on each supported container 130 can be opened to release the bulk material via gravity onto the delivery conveyor 120, which then can direct the dispensed bulk material towards the blender inlet. As shown in FIG. 1, some embodiments of the support structure 118 can comprise a discharge funnel 1301 configured to direct proppant from the discharge gate of the container 130 to the delivery conveyor 120 (see FIG. 13 for an example of such a funnel). In embodiments, the discharge funnel bottom end may be lower than the side edges of the curved discharge conveyor 120.

In some embodiments, each support structure 118 may be equipped with a plurality of locator pins disposed on top of the frame (e.g. on the upper surface) for locating and holding the containers on the frame. The containers 130 may include complementary engagement features designed to interface with the locator pins, thus enabling a precise placement of the containers into desired locations on the frame. In some embodiments, the locator pins can be disposed at the corners on the upper face of the frame. However, other placements of the locator pins along the upper surface of the support structure 118 may be utilized in other embodiments.

In some embodiments, each support structure 118 may also include one or more actuators designed to aid in actuation of a discharge gate of the one or more containers disposed on the frame. For example, the actuators may be rotary actuators designed to rotate into engagement with a discharge gate of a container to transition the gate between a closed position and an open position. In other embodiments, the actuators may be linear actuators designed to interface with the gates of the containers to selectively open and close the gates. In some embodiments, the actuators may include a set of two actuators (disposed on opposite sides of the frame) for actuating the discharge gate of a single container disposed on the frame. In such an arrangement, one of the actuators may transition the gate from closed to open, while the opposite actuator may transition the gate from open to closed

Typically, each support structure 118 holds a container 130 filled with proppant. While the same proppant may be used in the surge hopper 115 and/or the two containers 130 on the support structures 118, in some embodiments the proppant in each full container can be different (e.g. from each other) and/or can be different from that in the surge hopper 115 (e.g. allowing the use of multiple proppant/sand types for some embodiments). In some embodiments, the surge hopper 115 can be configured to provide the main proppant supply (e.g. the primary type of proppant), while the containers 130 can provide secondary and/or third types of proppant. Typically, the different types of proppant may be placed on the delivery conveyor 120 one at a time (e.g. serially). As noted above, in other embodiments, the containers 130 on the support structures 118 and the surge hopper 115 can all have the same type of proppant.

In some embodiments, the system may further comprise a removable buffer container 130 for each support structure 118, wherein each container 130 is removably disposed on the corresponding support structure 118 and is (e.g. initially) full of proppant (e.g. providing buffer volume of proppant, for example for use if the surge hopper 115 runs out of proppant/empties). Typically, all of the containers 130 (including those of the support structures 118, those in the buffer storage area 186, and those in the refill station(s) 161) are substantially identical (e.g. so that they can all be used interchangeably).

Typically, the unloading conveyor 105 is not configured to fill the buffer containers 130 on the support structures 118 (e.g. the unloading conveyor does not extend sufficiently and/or at least one of the containers of the support structures are not disposed on the radial arc of the unloading conveyor), although that may be provided in other embodiments. As shown in FIG. 1, the unloading conveyor 105 can be disposed on a first side of the delivery unit, 110 and a second side of the delivery unit 110 (e.g. opposite the first side) can be configured to allow access (e.g. to the forklift 189) for loading and unloading containers 130 on the support structures 118 (e.g. second side has open space in proximity to at least the support structures 118). For example, the forklift can remove empty containers 130 from the support structure 118 and/or load full containers 130 (e.g. filled at the refill station) onto the support structure 118.

While the exemplary details discussed above may be applicable to various system embodiments, in the specific system embodiment illustrated in FIG. 1, the unloading conveyor 105 is configured to be rotatable (e.g. to pivot) between two or more stations/positions, wherein one (e.g. the primary) station is the surge hopper 115. In FIG. 1, the second station 162 comprises one or more (e.g. two) refill stations 161 for empty buffer container(s) 130. Thus, in FIG. 1 the unloading conveyor 105 is configured to move the discharge end 107 along a radial arc 169 between the surge hopper 115 and the refill stations 161 of the secondary station (e.g. both the surge hopper 115 and the refill station 161 are located on the radial arc 169).

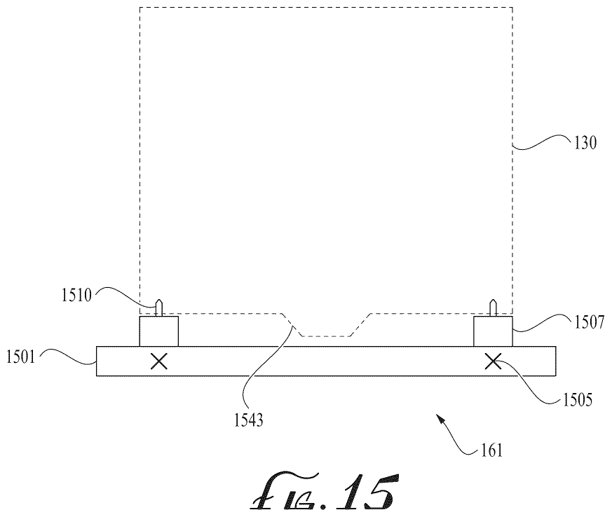

In FIG. 1, the unloading conveyor 105 comprises an offloading portion 108, having the receiving end 106, and a radial portion 109, configured to angle upward to the discharge end 107. Typically, both the offloading portion 108 and the radial portion 109 can comprise a belt configured for transport of proppant. In embodiments, the discharge end 107 height of the radial portion 109 can be height adjustable (e.g. for example if the second station and the primary station have different discharge heights). Typically, during rotation between stations, the offloading portion 108 does not rotate, while the radial portion 109 rotates between stations (e.g. pivoting at the end of the radial portion in proximity to the offloading portion to reposition the discharge end 107 along a radial arc 169). In some embodiments, the radial portion 109 may comprise a hopper 109a configured to receive proppant from the offloading portion 108 (e.g. at the end proximal to the offloading portion/the opposite end from the discharge end). In some embodiments, the hopper 109a may aid in allowing rotation of the radial portion 109 with respect to the offloading portion 108, while maintaining effective transport therebetween. See for example FIG. 14, illustrating an embodiment of the unloading conveyor 105.

In some embodiments, the radial portion 109 may operate faster than the offloading portion 108 (e.g. belt speed). While various forms of rotation can be used, in the embodiment illustrated in FIG. 14 the radial portion 109 comprises wheels 109b and/or a motor 109c configured to pivot the radial portion 109 along the radial arc 169 and/or between stations. For example, rotation/pivoting of the unloading conveyor 105 may be motor driven (e.g. with the motor operating the wheels to move the discharge end along the radial arc, while the offloading portion stays substantially stationary). In some embodiments, movement of the unloading conveyor 105 may be automated. For example, a controller 199 may automatically move/rotate the unloading conveyor by activating the motor 109c (e.g. based on sensor data, for example regarding fill levels of proppant for the surge hopper 115). For example, in the event that the surge hopper 115 is sensed to be full (e.g. reaching its capacity), the controller 199 may receive the sensed information and, based on that information meeting pre-set criteria indicative of max capacity, activate the motor 109c to move the discharge end 107 from the surge hopper 115 to the second station 162 (e.g. rotating towards the refill station 161). Similarly, in the event that the surge hopper 115 is no longer full, the controller 199 may receive the sensed information and, based on that information meeting pre-set criteria indicative of the surge hopper having capacity, activate the motor 109c to move the discharge end 107 back to the surge hopper 115 (e.g. rotating towards the surge hopper). In the event that the surge hopper 115 is still sensed to be full and the first container 130 at the first refill station 161a is sensed to be full, the controller 199 may receive the sensed information and, based on that information meeting pre-set criteria indicative of both the surge hopper 115 and the first container at the first refill station 161a being full, activate the motor 109c to move the discharge end from the first refill station 161a to the second refill station 161b (rotating between refill stations). In some embodiments, the secondary station 162 can comprise one or more (e.g. typically two or more) refill stations 161, each configured to hold an empty buffer container 130 positioned on the radial arc 169 (e.g. for the unloading conveyor 105 in its second position/station to refill a corresponding empty buffer container 130).

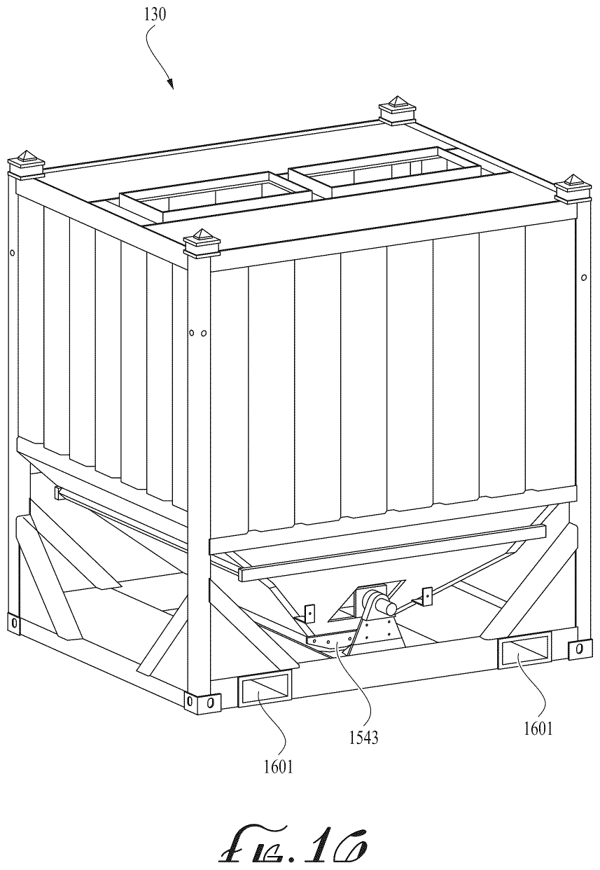

Typically, each refill station 161 can comprise a pad 1501 (e.g. configured to support the corresponding container), one or more locator elements 1510 (e.g. configured to orient the container on the pad 1501 and/or configured to correspond to complementary elements on the bottom of the container 130), and/or one or more sensors 1505 (e.g. configured to detect the presence of a container and/or the fill level of the container, such as a load cell). FIG. 15 illustrates an exemplary refill station 161. For example, the sensor 1505 can be configured to indicate the presence/amount of proppant/fill within each container 130 and/or the presence of a corresponding container 130). Typically, each refill station 161 may be substantially identical.

In some embodiments, each refill station 161 may be similar in structure to the support surface of the support structures 118 of the delivery unit 110. In some embodiments, the pad 1501 may comprise a plurality of supports 1507 configured to support the container 130 with its discharge gate 1543 above the ground (e.g. to provide clearance for the discharge gate 1543, which is configured so that when open proppant can flow out the bottom of the container 130, for example due to gravity feed), and in some embodiments, the sensors (e.g. load cells) 1505 can be disposed between or under the supports 1507. In some embodiments, the container 130 on its pad on the refill station 161 may be less than approximately 20 (e.g. less than 15 or less than 10) feet high. When discharging proppant to a container 130 on the refill station 161, the discharge end 107 of the unloading conveyor may be substantially the same height as the corresponding container 130. As shown in FIG. 1, each container 130 at a refill station 161 can be disposed on its pad 1501, which can be located on the radial arc 169 of the discharge end 107 of the unloading conveyor 105 (e.g. so that the unloading conveyor 105 can discharge proppant into the container 130). As shown in FIG. 1, the second station 162 can comprise at least two refill stations 161, all of which can be positioned on a portion of the radial arc 169 extending between the rear of the delivery unit 110 and a buffer container storage area 186 (e.g. with the delivery unit 110 disposed between the refill stations 161 and the blender 150).

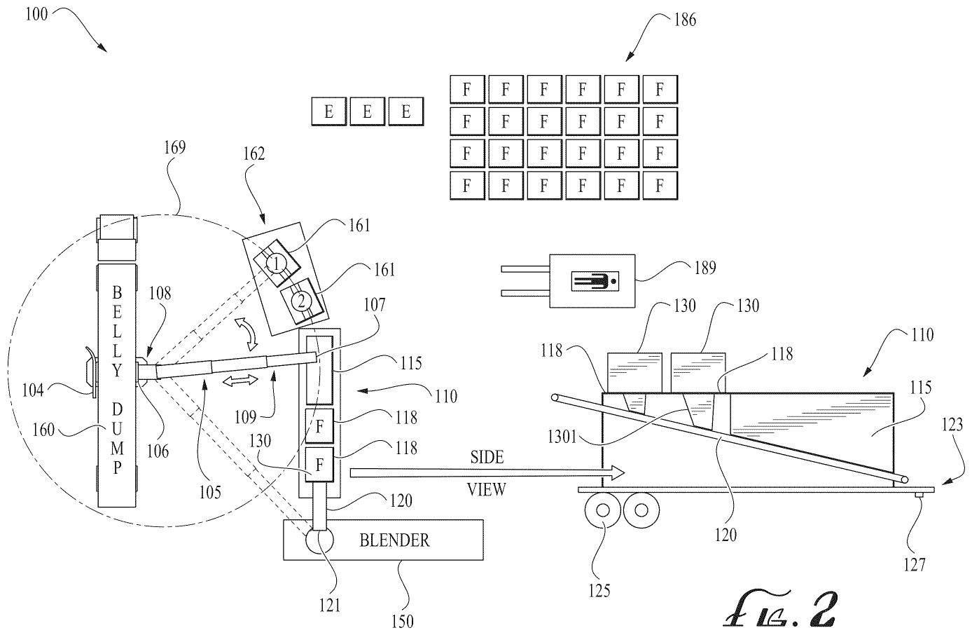

FIG. 2 illustrates an alternate system embodiment which is similar in many ways to the embodiments described with respect to FIG. 1 (e.g. including rotation/pivoting of the unloading conveyor 105 between the surge hopper 115 and the refill station(s) 161), but also is configured with a telescoping unloading conveyor 105. The combination of rotation and telescoping may allow for positioning of the discharge end 107 of the unloading conveyor 105 at the blender inlet in some instances, allowing for direct discharge of proppant to the blender 150 (e.g. at this third station/position). For example, the unloading conveyor 105 can further be configured for telescoping (e.g. with extendable and/or retractable length, as well as rotation/pivoting). Thus, in addition to directing proppant to the primary station (e.g. surge hopper 115) and second station (e.g. refill stations 161 for empty containers), the unloading conveyor 105 can be further configured to discharge proppant to a third station (e.g. directly to the blender 150, for example directly into the blender inlet/hopper).

In this embodiment, the blender inlet is not positioned on the radial arc 169 of the unloading conveyor 105, such that rotation alone would not allow for positioning for discharge directly to the blender 150. For example, to discharge proppant directly to the blender 150, the unloading conveyor 105 can be configured to rotate (e.g. towards the blender 150) and telescope (e.g. extend) to place the discharge end 107 at the third station/blender inlet (for direct discharge into the blender inlet and/or direct metering of proppant into the blender 150). In some embodiments, the unloading conveyor 105 can be configured with variable speed (e.g. to allow metering of proppant for job).

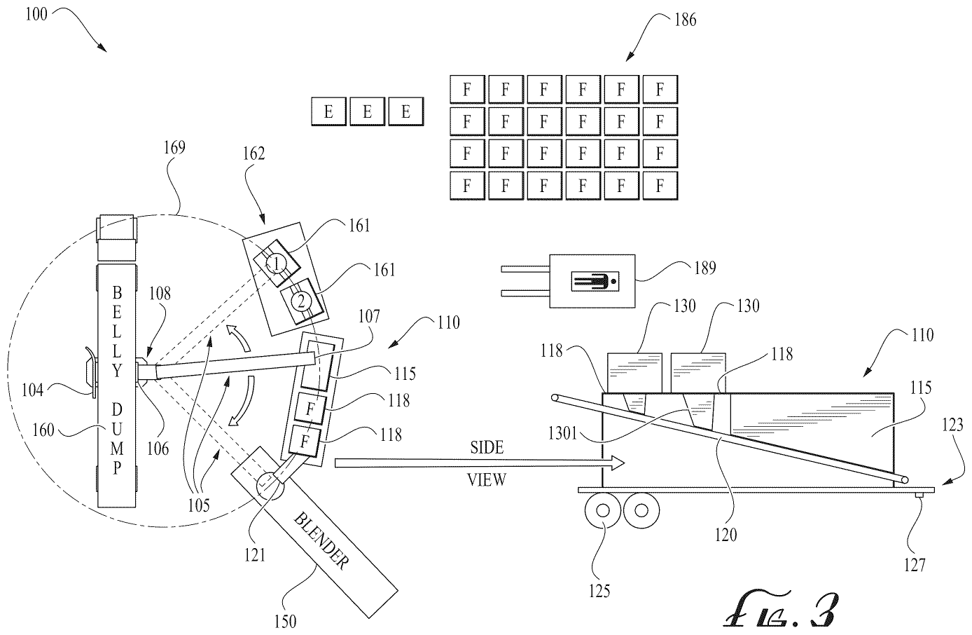

FIG. 3 illustrates another embodiment similar in some ways to FIG. 1 and/or FIG. 2, which allows for direct feed of proppant to the blender 150 using the unloading conveyor 105 (e.g. at a third station). In the embodiment of FIG. 3, both the blender 150 inlet and surge hopper 115 (along with the refill station 161) are located on the radial arc 169. Thus, movement to the third station (e.g. the blender inlet, which is located on the radial arc 169) may be accomplished with rotation alone (e.g. no need for telescoping). So in FIG. 3, the unloading conveyor 105 can pivot along a radial arc 169, but can have a fixed length (e.g. with direct discharge to the blender possible due to orientation of the blender 150 so that its inlet is disposed on the radial arc 169).

So for example, both the blender inlet and the surge hopper 115 (as well as the refill station(s) 161 in some embodiments) can be disposed on the radial arc 169 of the unloading conveyor 105. For example, this may be accomplished in some embodiments by having the delivery unit 110 oriented to place both the blender feed end 121 of delivery unit 110 and the surge hopper 115 on the radial arc 169 of the unloading conveyor 105. So in addition to directing proppant to the primary station (e.g. surge hopper 115) and second station (e.g. refill stations 161 for empty containers) as in FIG. 1, the unloading conveyor 105 can further be configured to discharge proppant to a third station (e.g. directly to the blender 150, for example directly into the blender inlet, with the unloading conveyor 105 being configured to rotate to the third station/blender inlet). For example, to discharge proppant directly to the blender 150, the unloading conveyor 105 can be configured to rotate (e.g. without extension) to place the discharge end 107 at the third station/blender inlet (e.g. for direct discharge into the blender inlet and/or direct metering of proppant into the blender 150). In some embodiments, the unloading conveyor 105 can have variable speed (e.g. to allow metering of proppant for the job).

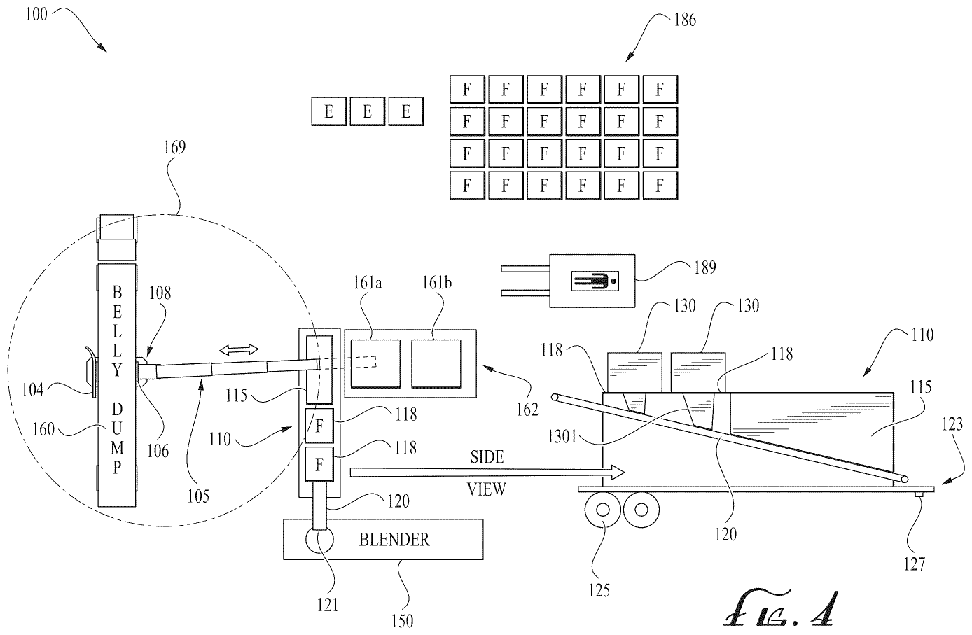

FIG. 4 illustrates yet another embodiment of the system 100, which may be similar in many ways to other embodiments discussed herein. In this embodiment, the discharge end 107 of the unloading conveyor 105 can move between the surge hopper 115 and the refill station(s) 161 without the need for rotation/pivoting. Instead, the unloading conveyor 105 may telescope between stations to reposition the discharge end 107 (e.g. all movement between stations may be using the telescoping of the unloading conveyor 105). In embodiments, the refill station(s) 161 can be disposed on the side of delivery unit 110 opposite unloading conveyor 105 and/or belly-dump truck 160, and can be oriented in line with the unloading conveyor 105 (e.g. the unloading conveyor 105, the surge hopper 115, and each of the refill stations 161 can be substantially in line, for example all oriented substantially along the longitudinal centerline axis of the unloading conveyor 105).

So for example, the unloading conveyor 105 can be configured for telescoping (e.g. extendable length), typically with no rotation/pivoting. In its retracted position, the telescoping unloading conveyor 105 can feed the surge hopper 115 (e.g. with the discharge end 107 positioned over the surge hopper 115), while in its extended position, the telescoping unloading conveyor 105 can feed empty container(s) 130 located at the refill station(s) 161 beside (e.g. adjacent to) the delivery unit 110 (e.g. on the opposite side from the belly-dump truck 160 and/or unloading conveyor 105 receiving end 106). Thus, the one or more empty container 130 at the refill station(s) 161 can be located in line with the unloading conveyor (e.g. so that simple extension of the unloading conveyor 105 can reposition the discharge end 107 at the refill station(s) 161). The unloading conveyor 105 can be configured to be telescoping between a primary station (e.g. the surge hopper 115) and a second station (e.g. one or more refill station 161 for refilling of one or more empty containers 130 thereat), allowing for discharge of proppant to the appropriate/desired station (e.g. merely by telescoping therebetween). For example, the second station 162 can be disposed beside (e.g. adjacent to) the delivery unit 110, opposite the belly-dump truck 160 and/or unloading conveyor 105 (e.g. the receiving end 106 of the unloading conveyor). When the unloading conveyor 105 is at the primary station, the discharge end 107 is disposed above the surge hopper 115; and when the unloading conveyor 105 is at the second station, the discharge end 107 is disposed above a refill station 161 and/or its empty container. Movement of the discharge end 107 between the primary and secondary station may be by telescoping (e.g. extension and/or retraction).

In some embodiments, as shown in FIG. 4 for example, the second station 162 can comprise two or more refill stations 161, each configured to hold an empty container 130 for refill. Typically, the two or more refill stations may be disposed in-line with each other and with the unloading conveyor 105 (e.g. with the surge hopper 115 located therebetween, and with the refill stations 161 located side-by-side next to the delivery unit 110, for example with a first refill station 161a disposed between a second refill station 161b and the surge hopper 115). Thus, movement between refill stations 161 can also be by telescoping (e.g. without rotation), for example with the unloading conveyor 105 having three telescoping positions corresponding to (1) the surge hopper 115, (2) the first refill station 161a, and (3) the second refill station 161b. In alternate embodiments, the second station 162 could include a chute system configured to direct proppant to the desired refill station 161 (e.g. without requiring movement of the discharge end between refill stations—for example with the unloading conveyor 105 telescoping only between the surge hopper 115 and the second station 162 generally). In other aspects, the system embodiment of FIG. 4 may be similar in many ways to earlier described systems, as may be seen for example in FIG. 4 and as will be understood by persons of skill based on this disclosure.

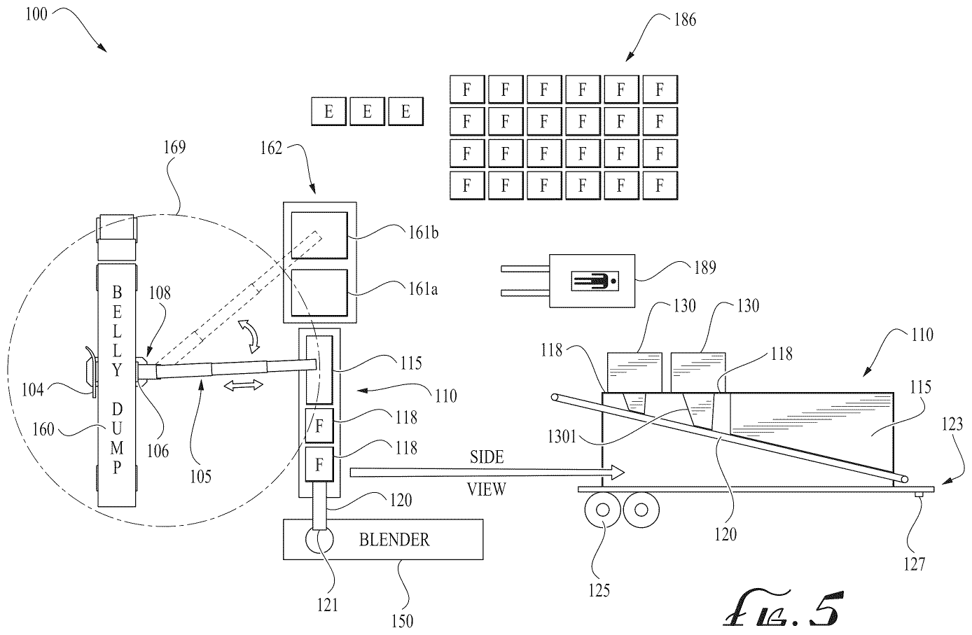

FIG. 5 illustrates still another system embodiment. In the embodiment of FIG. 5, the unloading conveyor 105 may be configured for both rotation/pivoting (e.g. along the radial arc 169) and telescoping (e.g. extension and/or retraction). For example, this may allow for location of the refill station(s) 161 behind the rear of the delivery unit 110 as shown in FIG. 5 (e.g. not disposed on the radial arc 169), with the discharge end 107 of the unloading conveyor 105 able to move between the surge hopper 115 (e.g. primary station) and the second station 162 (e.g. having one or more refill stations 161).

So for example, the unloading conveyor 105 of FIG. 5 can be configured for telescoping and rotation/pivoting. Typically, the second station 162 can be disposed behind (e.g. adjacent to) a rear of the delivery unit 105 (e.g. in line with the delivery conveyor 120 and/or distal to the blender feed end 121of the delivery conveyor 120 and/or the blender inlet), with the delivery unit 110 disposed between the blender 150 and the second station 162. The unloading conveyor 105 can be configured to rotate and telescope to place the discharge end 107 at the second station 162 (for discharge of proppant for refilling of empty containers) (e.g. allowing movement of the discharge end between the surge hopper 115 and the second station 162). For example, the telescoping unloading conveyor 105 may be in retracted position (and at a first radial position along the radial arc 169, for example proximal to the blender 150) while feeding the surge hopper 115 (e.g. with the discharge end 107 positioned over the surge hopper 115), and the telescoping unloading conveyor 105 can be in extended position (and rotated/pivoted to a second radial position along the radial arc 169 with respect to the primary station, for example distal to the blender 150) while feeding empty container(s) located to the rear of the delivery unit 110 (e.g. at the second station 162).

Thus, when the unloading conveyor 105 is at the primary station (surge hopper 115) (e.g. based on the first rotational position and retracted telescoping position), the discharge end 107 is disposed above the surge hopper 115; and when the unloading conveyor 105 is at the second station 162 (e.g. based on the second rotational position and extended telescoping position), the discharge end 107 is disposed above a refill station 161 and/or empty container 130 (e.g. disposed behind/to the rear of the delivery unit 110/surge hopper 115). In some embodiments, the second station 162 can comprise two or more refill stations 161, each configured to hold an empty container for refill. For example, the two or more refill stations 161 can be disposed in line with the delivery unit 110 (e.g. with the delivery unit 110 disposed between the refill stations 161 and the blender 150, and the refill stations 161 located directly behind the delivery unit 110). In such embodiment, the unloading conveyor 105 can comprise the retracted position (e.g. at a first radial position on the radial arc 169 corresponding to the surge hopper 115), a first extended position (e.g. so that when used with a first amount of rotation along the radial arc 169 to a second radial position, the discharge end 107 is disposed above the first refill station 161a), and a second extended position (e.g. so that when used with a second amount of rotation along the radial arc 169 to a third radial position, the discharge end 107 is disposed above the second refill station 161b, with the second extended position of FIG. 5 greater than that of the first extended position). In other aspects, the system embodiment of FIG. 5 may be similar in many ways to earlier described systems, as may be seen for example in FIG. 5 and/or understood by persons of skill based on this disclosure.

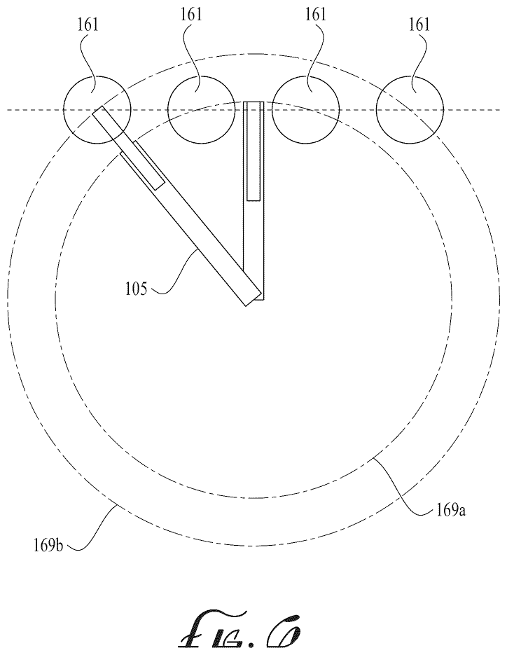

FIG. 6 schematically illustrates yet another system embodiment, similar to that of FIG. 1 but also utilizing a telescoping unloading conveyor 105 to allow for more complex configurations (e.g. of refill stations). For example, the refill stations 161 can be located on (e.g. two, or more) concentric radial arcs 169a, 169b. So in FIG. 6, the unloading conveyor 105 can be configured for telescoping (e.g. as well as rotation/pivoting, for example along a radial arc). Thus, by telescoping, the unloading conveyor 105 can move the discharge end 107 through at least two concentric radial arcs 169a, 169b (e.g. depending on the number of extension positions available). The refill stations 161 are disposed on the concentric radial arcs 169a, 169b of the unloading conveyor 105. For example, the second station 162 can comprise a plurality of refill stations 161, with two or more of the plurality of refill stations 161 disposed on the first radial arc 169a of the retracted/un-extended telescoping unloading conveyor 105, and two or more of the plurality of refill stations 161 disposed on a second radial arc 169b of the extended telescoping unloading conveyor 105. The unloading conveyor 105 can be configured to rotate and telescope/extend to position the discharge end 107 above the refill stations 161 disposed on the second radial arc 169b (for discharge of proppant for refilling of empty containers there), and the unloading conveyor 105 configured to rotate and retract to position the discharge end 107 above refill stations 161 disposed on the first radial arc 169a. The combination of radial arc position and extension can be used to move the discharge end to various refill stations on the concentric radial arcs of the embodiment (e.g. with FIG. 6 illustrating an embodiment with two radial arcs 169). For example, two or more refill stations 161 can be disposed on each radial arc 169, and each refill station 161 can have an empty container 130 disposed thereat. In other aspects, the system embodiment of FIG. 6 may be similar in many ways to earlier described systems (e.g. such as FIG. 1), as may be seen for example in FIG. 6 and as may be understood by persons of skill based on this disclosure.

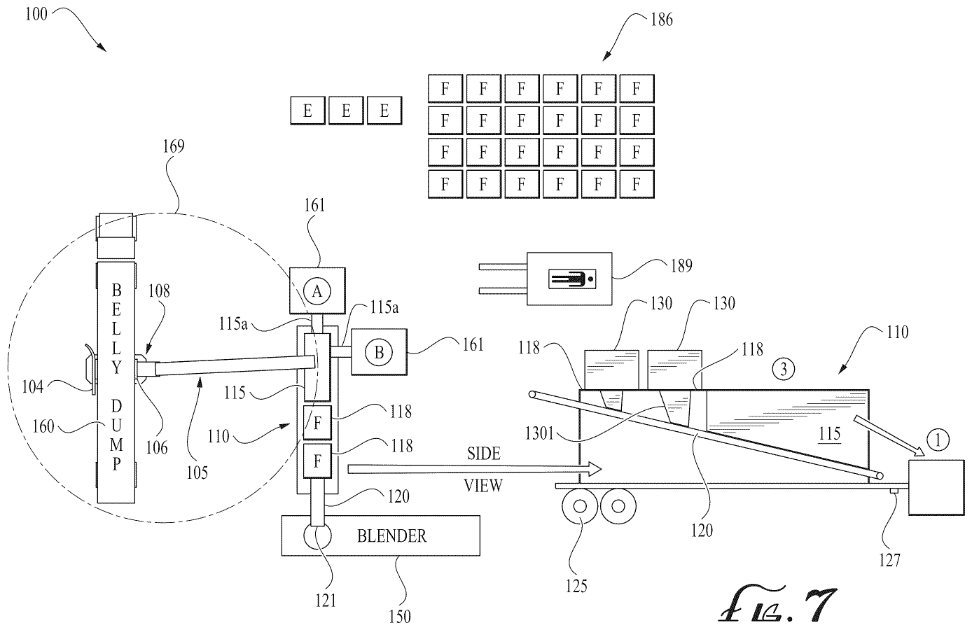

FIG. 7 illustrates still another system embodiment. This embodiment still addresses excess proppant capacity (e.g. above what the surge hopper 115 can handle) by moving proppant to containers 130 at one or more refill stations 161, but it does so without moving the discharge end 107 of the unloading conveyor 105 (e.g. no rotation or extension, with the discharge end 107 instead fixed in position over the surge hopper 115). For example, the discharge end 107 of the unloading conveyor 105 in FIG. 7 is disposed over and/or feeds into the surge hopper 115 of the delivery unit 110. A refill station 161 can be disposed adjacent to and/or in proximity to the surge hopper 115, and the surge hopper 115 can further comprise an overflow element 115a (e.g. a valve and/or chute, etc.) configured to direct proppant from the surge hopper 115 to the refill station 161 having an empty container (e.g. responsive to the surge hopper 115 exceeding capacity).

In other words, proppant is directed from the surge hopper 115 to the refill station 161 when the surge hopper capacity is met (e.g. when the surge hopper 115 becomes sufficiently full, proppant from the surge hopper 115 is direct (e.g. by the overflow element 115a) to the refill station 161, thereby preventing overflow of the surge hopper 115 with proppant falling uncontained, for example on the ground). Thus, the refill station 161 is indirectly fed (e.g. not directly from the unloading conveyor 105 transporting proppant from the belly-dump truck 160, but from the surge hopper 115 after it receives excess proppant from the unloading conveyor 105). In embodiments, the overflow element 115a can be opened (e.g. by the controller 199) to transfer overflow/excess proppant from the surge hopper 115 to the refill station 161, providing more capacity in the surge hopper 115 for proppant arriving from the unloading conveyor 105 to the surge hopper 115.

Typically, the refill station 161 (e.g. an empty container at the refill station) can be disposed beneath/under the overflow element 115a, and typically the overflow element 115a can be configured for gravity feed of proppant from the surge hopper 115 (e.g. in proximity to its open top) to the refill station 161 (e.g. the empty container 130 thereat). In some embodiments, the refill station 161 can be disposed adjacent the rear of the delivery unit 110 and/or surge hopper 115 (e.g. distal to the blender feed end 121 of the delivery conveyor 120) or adjacent a side of the delivery unit 110 and/or surge hopper 115 opposite the belly-dump truck 160, the unloading conveyor 105, and/or the receiving end 106 of the unloading conveyor. Some embodiments may further comprise a second refill station 161 disposed adjacent to and/or in proximity to the surge hopper 115, for example with the first refill station 161a disposed adjacent the rear of the delivery unit 110 and/or surge hopper 115 (e.g. distal to the discharge end 121 of the delivery conveyor 120), and the second refill station 161b disposed adjacent a side of the delivery unit 110 and/or surge hopper 115 opposite the belly-dump truck 160, the unloading conveyor 105, and/or the receiving end 106 of the unloading conveyor.

Typically, the overflow element 115a can be configured to direct overflow of proppant (e.g. when the surge hopper 115 is approximately full of proppant) to the first and/or the second refill stations 161. For example, the overflow element 115a can be configured to selectively (e.g. switching between) direct proppant from the surge hopper 115 to the first refill station 161a and/or the second refill station 161b. Often, the empty container at one of the refill stations 161 is filled first, before the overflow element 115a switches to direct proppant to the other refill station 161. In some embodiments, the overflow element 115a can be controlled by the controller 199, which may open the overflow element 115a (e.g. when the surge hopper 115 has no more capacity), close the overflow element (e.g. to maintain proppant in the surge hopper and/or prevent flow of proppant to the refill station 161), and/or switch/direct flow between refill stations 161 (e.g. when one refill station reaches capacity, switching to direct proppant to another refill station). The controller 199 may operate the overflow element 115a based on sensor data. In some embodiment, the first and second refill stations 161 are disposed to provide access to containers on both by the forklift 189. In other aspects, the system embodiment of FIG. 7 may be similar in many ways to earlier described systems, as may be seen for example in FIG. 7 and/or as may be understood by persons of skill based on this disclosure.

FIG. 15 illustrates an exemplary refill station 161. In some embodiments, each refill station 161 may be similar to the (e.g. upper surface of the) support structures 118 on the delivery unit 110. For example, the pad of the refill station 118 can include supports 1507 configured to hold the container sufficiently above the ground/pad to provide clearance for the discharge gate 1543, for example with support located around a perimeter and an open area in between. Some embodiments may include one or more locator 1510 (e.g. on the supports), which can be configured to interact with corresponding elements on the bottom of the container 130 to help orient the container 130 atop the supports 1507. In some embodiments, the refill station 161 may include one or more sensor 1505, for example similar to those described with respect to the support structure 118. For example, the sensor(s) 1505 can be configured to detect the presence of a container and/or the amount of proppant (e.g. the used capacity of the container, and thereby the available capacity of the container, and/or whether the container is empty or full). The information from the sensor(s) 1505 may be communicated to the controller 199, which may utilize such information to determine operational commands.

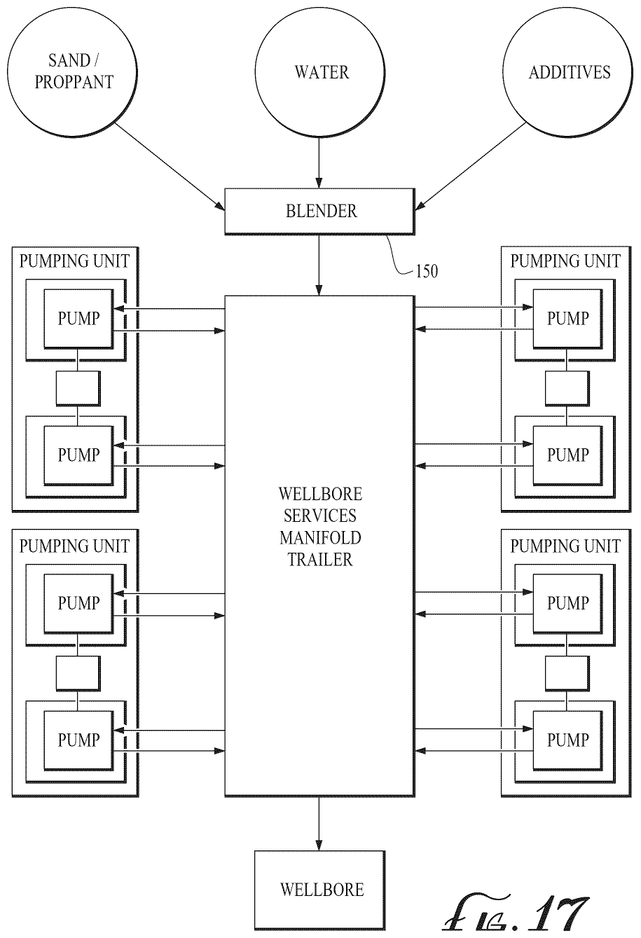

Some embodiments can further comprise a plurality of buffer containers 130 (see for example FIG. 1), which can be disposed at a buffer storage station 186 (and also may be used at the refill station(s) 161 and the support structures 118 of the delivery unit 110). See FIG. 16 for an example of a container 130 embodiment. These containers 130 generally include a discharge gate 1543 at the bottom that can be actuated to empty the material contents of the container (e.g. bulk material) at a desired time. In some embodiments, the containers 130 may include one or more (e.g. typically two) slots 1601 configured to correspond to the tines of the forklift, to allow for forklift interaction to lift and move the container 130 about the site. In some embodiments, the slots 1601 may be disposed in proximity to the bottom of the container. The containers 130 typically are portable (e.g. capable of being moved about the site using a forklift, such as 189, and/or capable of being transported between sites), being separate and apart from the refill station 161, the supporting structure 118, and/or the buffer storage station 186 upon which it may be removably placed.

In some embodiments, the containers 130 may include one or more complementary engagement features designed to interface with the locator element(s) 1510 of the support structure 118 and/or the refill station 161, which can enable the container to be precisely placed and/or secured onto a refill station 161, a supporting structure 118, a truck or other transport device (e.g. during movement of containers to and from the site), or atop another similar container (e.g. allowing for stacking of containers, for example for storage, for example at buffer storage station 186). Typically, each container 130 may hold approximately 40,000 to 45,000 pounds (e.g. 40,000-42,000 pounds) of proppant (e.g. less volume than the surge hopper 115, for example two containers may be needed to hold the volume of proppant in the belly-dump truck 160 and/or surge hopper 115). Typically, all of the containers 130 on site are substantially similar, for example allowing for any one container 130 to be used at various stations alternately.

In some embodiments, the plurality of containers 130 can be held at the buffer storage station 186. For example, the buffer storage station 186 and/or the plurality of containers 130 may comprise approximately 20-100 (or 50-100 or 40-60) containers 130. See for example FIG. 1 for illustration. Typically, the majority of the plurality of containers 130 (e.g. at least 20, at least 30, at least 50, or at least 75) are full of proppant, but a number of containers 130 are empty (e.g. held in reserve for use at the refill station(s) 161 to address any amount of proppant from the belly-dump truck 160 that cannot fit within the surge hopper 115 (e.g. for use when the surge hopper is full)). For example, the number of empty containers 130 (e.g. initially) can be approximately 1/10 to ¼ or approximately 1/10 to ⅛ or approximately ⅛ to ¼ the number of full containers.

In some embodiments, the plurality of containers 130 (initially) can comprise a number of full containers sufficient to provide proppant for the overall system operation (e.g. for well treatment) for approximately 4-6 hours of pumping. So for example, if trucking delivery of proppant is delayed by less than 4-6 hours, the system 100 may nevertheless operate substantially continuously. In some embodiments, the plurality of containers 130 (initially) comprises a number of empty containers with total volume of equal to approximately a volume of the surge hopper 115 (or with volume no less than that of the surge hopper 115, for example approximately 2-5 or 2-3 empty containers, no more than 5 empty containers, and/or at least 2 empty containers). In some embodiments, the buffer storage station 186 can be located some distance away from the blender 150 and/or the delivery unit 110, for example with an area designated for forklift operations disposed therebetween. Typically, the delivery unit 110 may be disposed between the blender 150 and the buffer storage station 186.

In some embodiments, the buffer storage station 186 can comprise a pad configured to hold/support the plurality of containers 130. In some embodiments, the containers 130 may all be located on the pad at ground level, but in other embodiments, container 130 may be stacked on the pad (e.g. at different levels). In some embodiments, the pad of the buffer storage station 186 can comprise a plurality of supports configured to support each of the plurality of containers 130 (e.g. on the ground level) with its discharge gate above the ground/base pad (e.g. providing clearance for the discharge gate). For example, the supports (for each container) of the pad of the buffer storage station 186 may be similar to the supports of the refill station 161 and/or the supporting structure 118. For example, some embodiments may comprise one or more locator element (e.g. to ensure proper alignment/orientation/placement of the container on the pad). For example, the locator elements of the pad may correspond to elements on the bottom of the container (such as complementary engagement features, in some embodiments). Some embodiments may also include sensors, for example similar to one or more of those of the refill station (e.g. so the available amount of buffer proppant and/or number of full and empty containers may be determined). The sensor information can be sent to the controller 199 for analysis.

In some embodiments, the pad may comprise two separate portions designated for full and empty containers. For example, the pad can comprise a first portion 186a, configured to hold full containers, and a second portion 186b configured to hold empty containers. In some embodiments, the second portion 186b can be separate from the first portion 186a of the pad (e.g. with spacing/gap therebetween). In some embodiments, the delivery unit 110 can be disposed between the blender 150 and the pad of the buffer storage station 186 (e.g. the pad can be located on the same side of the blender as the delivery unit). In some embodiments, the second portion 186b of the pad can be located closer to the secondary/refill station 161 than the first portion 186a (e.g. the second portion 186b can be disposed between the first portion 186a of the pad and the secondary/refill station 161). In some embodiments, the second portion 186b of the pad may be disposed on the radial arc 169 of the unloading conveyor 105, and may for example serve simultaneously as the second station 162 with refill stations 161 (e.g. there may be no separate storage station for empty containers, and all of the empty containers may be stored at refill stations 161).

Some system embodiments can further comprise a blender 150 having a blender inlet/hopper, and the delivery conveyor 120 can be configured to feed the blender inlet/hopper (e.g. by gravity drop of proppant into the top of the blender inlet/hopper from the blender end 121 of the delivery conveyor 120). The term “blender inlet” used herein may refer to any number of inlets to tubs, hoppers, mixers, and other areas where bulk material is needed. As mentioned above, the blender inlet may be associated with a blender 150 disposed at a job site (e.g., at a well site). For example, the blender inlet may be a blender hopper (e.g., hopper) used to provide bulk material to a metering system that meters the bulk material into a mixer. In other embodiments, the blender inlet may be an inlet directly into a mixing vessel of a blender. Persons of skill will understand various aspects of the blender 150 based on this disclosure.

In some embodiments, the delivery unit 110 can be disposed between the blender 150 and the plurality of containers and/or pad of the buffer storage station 186. In some embodiments, the blender 150 can be configured to mix the proppant (e.g. delivered by the delivery unit 110) with liquid (e.g. water) to form fracturing fluid for use downhole in a well (e.g. a hydrocarbon well). In some embodiments, the blender 150 may be separate and apart from the delivery unit 110, but in other embodiments the blender 150 may be integral to the delivery unit (e.g. with the blender mounted on the trailer). Although the blender 150 can be oriented in various positions with respect to the delivery unit 110, in FIG. 1 the blender 150 extends approximately perpendicularly with respect to the delivery unit 110.

In embodiments, the blender 150 may include a hopper and a mixer (e.g., mixing compartment). The blender unit 150 may also include a metering mechanism for providing a controlled, i.e. metered, flow of bulk material from the hopper to the mixer. However, in other embodiments the blender unit 150 may not include the hopper, such that the blender feed end 121 of the delivery conveyor 120 (which may be situated at an elevation above the inlet for the blender 150) may provide bulk material directly into the mixer (e.g. with metering provided by its speed).

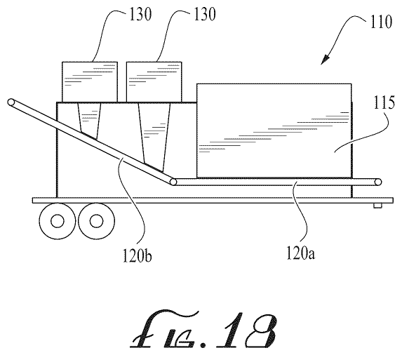

Typically, water and other additives may be supplied to the mixer of the blender 150 (e.g., mixing compartment), for example through a fluid inlet. As those of ordinary skill in the art will appreciate, the fluid inlet may comprise more than one input flow line in some embodiments. The bulk material and water may be mixed in the mixer of the blender 150 to produce (at an outlet of the blender) a fracking or other well treatment fluid, a mixture combining multiple types of proppant, proppant/dry-gel particulate mixture, sand/sand-diverting agents mixture, cement slurry, drilling mud, a mortar or concrete mixture, treatment fluid, or any other fluid mixture for use on location. The outlet of the blender 150 may be coupled to one or more pump (see for example FIG. 17, illustrating an exemplary wellbore treatment system in which treatment fluid from the blender 150 is pumped, for example by interaction of one or more mobile pumping units with a mobile wellbore services manifold trailer, to the wellbore) for conveying the treating fluid to a desired location (e.g., a hydrocarbon recovery well) for a treating process. It should be noted that the disclosed system 100 may be used in other (e.g. non-proppant) contexts as well. For example, the proppant delivery system 100 may be used in concrete mixing operations (e.g., at a construction site) to dispense aggregate into a concrete mixing apparatus. In addition, the proppant delivery system 100 may be used in agriculture applications to dispense grain, feed, seed, or mixtures of the same.

Some systems can further comprise a belly-dump (e.g. bottom hopper) truck 160 configured to empty proppant from its underside (e.g. onto the receiving end of the unloading conveyor). See FIG. 8 for an example of a belly-dump truck embodiment. It should be understood that any usage of “belly-dump truck” herein is exemplary and is intended to include all proppant transport vehicle embodiments, particularly gravity-feed transport vehicles in which bulk proppant can be dumped from the truck/trailer, including but not limited to end-dump trucks, side-dump trucks, and similar trailers configured to be pulled by a conventional truck. Typically, the belly dump truck 160 an be configured to hold/transport approximately 50,000 to 80,000 pounds (e.g. 50,000 to 54,000 pounds or 53,000 to 54,000 pounds) of proppant. For example, the belly dump truck 160 can be configured to hold such an amount of proppant without exceeding DOT limits. In some embodiments, the belly-dump truck 160 can comprise an enclosure (e.g. belly hopper) configured to hold the load of proppant, and a bottom hopper (e.g. clamshell gate) which, when open, is configured to unload (via gravity drop) the proppant payload. In some embodiments, such as shown in FIG. 8, the belly-dump truck 160 may comprise a trailer which can be pulled by a separate truck (e.g. a standard truck).

Some system embodiments can further comprise a forklift 189 or other mechanism (such as a crane) configured to move containers 130 on-site (e.g. from the second portion 186b of the pad to the refill station 161, from the refill station 161 to the first portion 186a of the pad, from the first portion 186a of the pad to the support structures 118 on the delivery unit, and/or from the support structures 118 on the delivery unit to the refill station 161 and/or second portion 186b of the pad). Typically, a conventional forklift can be used, for example having tines for lifting and/or a maximum load capacity of approximately 55,000 lbs (e.g. sufficient to lift a full container of proppant, for example with the empty container weighing approximately 6,000-7,000 lbs and a proppant payload of approximately 40,000-45,000 lbs when full). Since forklift traffic may be reduced by the disclosed system 100 (e.g. since container movement may be limited to instances when direct delivery to the surge hopper has issues), a single forklift 189 may be sufficient to operate the system 100 (e.g. move the required containers) and/or on site (although in some embodiments, a second forklift could be kept in reserve in case of forklift malfunction or maintenance).

In embodiments, the space between the delivery unit 110 and the buffer storage station 186 can be configured to provide open/free access to the forklift 189 (e.g. that space can be open to allow movement of the forklift 189 between the delivery unit 100, the secondary station 162, and the buffer storage station 186). In some embodiments, the forklift path can be disposed on the side of the delivery unit 100 opposite the unloading conveyor and/or belly-dump truck 160, on the same side of the blender 150 as the delivery unit 110, and/or between the blender 150 and the buffer storage station 186. Typically, (e.g. at least the portion in proximity to the support structures 118 of) the side of the delivery unit 110 opposite the belly-dump truck and/or the unloading conveyor can be kept accessible for the forklift 189, for example so that the forklift can move containers to and from the support structures 118. And as noted above, the containers 130 are typically configured for movement by the forklift 189 (e.g. with slots configured to receive the tines of the forklift).

As previously noted, some system embodiments can comprise a controller and/or control system 199. The controller 199 can be communicatively coupled to sensors, motors (e.g. for positioning system elements), etc., and in some instances may allow for partial or full automation of the system 100. The system 100 (for example, the unloading conveyor 105, the delivery unit 110, the refill station(s) 161, and/or the buffer storage station 186) may include a number of electronic components, and these components may be communicatively coupled (e.g., via a wired connection or wirelessly) to one or more controllers 199 (e.g., automated control system) at the well site. In some embodiments, the control system 199 may be communicatively coupled to several other well site components including, but not limited to, the blender unit 150, a hoisting mechanism (e.g., forklift) 189, and various sensors.

The control system 199 can utilize at least a processor component and a memory component to monitor and/or control various operations and bulk material inventory at the well site. For example, one or more processor components may be designed to execute instructions encoded into the one or more memory components. Upon executing these instructions, the processors may provide passive logging of certain operations at the well site, as well as the amount, type, and location of bulk materials at the well site. In some embodiments, the one or more processors may execute instructions for controlling operations of certain well site components (e.g., system 100 electronics, blender unit 150, hoisting mechanism 189, etc.). This may help to control transportation and placement of the delivery unit 110 relative to the blender inlet, transportation and placement of the unloading conveyor 105, positioning (e.g. rotation/pivoting and/or telescoping) of the unloading conveyor discharge end 107, transportation and placement of the refill station(s) 161, transportation and placement of the bulk storage station 186, as well as bulk material transfer at the well site. For example, the processors may output signals at a user interface for instructing operators to remove an empty container from the support structure 118 and replace the container with a new container holding a certain type of bulk material needed for the well treatment, instructing an operator to move a filled container from the refill station 161 and to replace it with an empty container from the bulk storage station, etc. Other types of instructions for inventory control/monitoring may be provided through the disclosed systems.

As shown, the system 100 may include a number of electronic components such as, for example, automated actuators which may be controlled to open and/or close a discharge gate of one or more containers elevated on the support structure 118. The support structure 118 may also include one or more indicators (e.g., indicator lights) disposed on the support structure for providing various information about the operating state of the support structure 118. The indicators may include lights designed to indicate whether the discharge gates of containers disposed on the support structure 118 are in an open position or in a closed position, based on the operating state of the corresponding actuators. Automatic actuators may also be used to operate the positioning of the unloading conveyor 105 (e.g. rotation/pivoting and/or telescoping).

In addition, the system 100 may include various sensors designed to take measurements and provide sensor feedback to the control system 199. For example, the support structure 118 may include cameras (e.g., all-weather cameras) to provide optical feedback of certain operations involving the support structure. One or more cameras may be positioned to look out toward where the hoisting mechanism (e.g. forklift) is manipulated to engage containers on the portable support structure 118 (e.g., proximate the slots). These cameras may detect a proximity of the hoisting mechanism 189 to the support structure 118 as the hoisting mechanism is maneuvered toward and into engagement with the support structure. The controller 199 may output signals to control an alignment of the hoisting mechanism (e.g., forklift) 199 toward the slots or other interface feature on the support structure, based on the optical feedback received from the cameras. Once aligned and fully engaged with the support structure 118, the hoisting mechanism 189 may be used to lift and transport the containers with respect to the support structure 118 and/or about the well site, as described above.

Additional cameras may be used to control a position of the blender unit 150 relative to the delivery unit 110 (e.g. relative to the blender feed end 121) during set up of the system 100 at a desired location. For example, the cameras may detect a proximity of the blender inlet (e.g., hopper or mixing vessel) to the blender feed end 121 as the delivery unit is being positioned relative to the blender unit 199. The controller 199 may output signals to control an alignment and proximity of the blender unit 150 relative to the delivery unit 110 (e.g. when the delivery unit is being positioned), based on the optical feedback received from the cameras.

The system 100 may also include fill level sensors (e.g., cameras, guided wave radar sensors, sonar sensors, array or level switches, or any other type of level sensing devices) which may operate with respect to the blender hopper, the containers/support structures, the containers/refill stations, and the containers/bulk storage station (e.g. with the sensors for example used to detect a level of the bulk material present and/or fill level). The controller 199 may receive inputs/information from the sensors and/or may output control signals to one or more elements (e.g. actuators on the support structure 199 to control discharge of proppant from the container of the support structure 118, actuators on the unloading conveyor to control rotation, telescoping, and/or belt speed, actuators on the delivery unit 110 to control delivery conveyor 120 speed, actuators on the surge hopper 115 to control the positioning of its front (e.g. size of the gap and/or amount of proppant dispensed therefrom), etc. For example, the controller 199 may operate based on the received fill level sensor signals, for example to maintain a substantially steady flow of bulk material (e.g. proppant) to the blender inlet and/or to prevent overflow of bulk material (e.g. proppant) from the surge hopper and/or containers. Based on the sensor inputs, the controller 199 may try to maintain substantially continuous feed of proppant to the blender 150, for example by providing instructions to operators and/or based on automation.

The support structure 118 (and similarly the surge hopper 115, the refill stations 161 and/or the buffer storage station 186) may also include load cells for detecting the presence and/or weight of the one or more containers disposed on the frame of the support structure 118. By detecting the weight of the containers, the load cells may provide the controller 199 with information regarding the number of containers disposed on the support structure 118 as well as the fill level of bulk material within the individual containers 130 on the support structure 118.

Other sensors may be present throughout the system 100. In some embodiments, for example, the system may include additional sensors for detecting the presence and/or location of one or more containers disposed atop the frame of the support structure 118, the refill stations 161, and/or the buffer storage station 186. The controller 90 may use this information to output a command for an operator or automated system regarding movement of containers 130, for example based on the received signal from the sensors.

The controller 199, the electronics, or both, may utilize power from an external power source. In other embodiments, the controller may include its own power source for operating the onboard electronics and sensors. As mentioned above, the controller 199 may be communicatively coupled to various other sensors and/or other elements disposed about the well site. In some embodiments, these sensors may include one or more load cells or bin full switches for tracking a level of bulk material in a portable container 130 and indicating whether the container is empty, full, or partially full. Such sensors may be used for any given container, the blender hopper, or any other component at the well site. In addition, in some embodiments the sensors may include RFID tags used to provide an indication of the particle size, bulk volume, weight, type, material, and/or supplier of the bulk material disposed in a certain container. In such instances, the controller 199 may be communicatively coupled to an RFID reader disposed in proximity to the containers being moved about the well site.

Also disclosed are method embodiments for installing (e.g. at a wellsite) a proppant delivery system (e.g. similar to those discussed herein) for wellbore services. For example, the method may comprise: providing a blender in proximity to the well configured to provide treatment fluid to the well; positioning a mobile delivery unit in proximity to a blender inlet/hopper of the blender, wherein a delivery conveyor of the delivery unit is configured to feed proppant into the blender inlet/hopper; installing a buffer container storage area configured to hold a plurality of buffer containers; installing one or more (e.g. two or more) refilling stations each configured to hold an empty container (e.g. configured to receive proppant in excess of the capacity of the surge hopper); and/or installing an unloading conveyor configured to receive proppant from a belly-dump truck, wherein the unloading conveyor is configured to provide proppant to a surge hopper of the delivery unit (e.g. which is configured to feed proppant to the delivery conveyor) and/or to the refill station(s). In some embodiments, the delivery unit can be disposed between the blender and the buffer container storage area. In some embodiments, the delivery unit can be disposed between the unloading conveyor (e.g. the receiving end) and the buffer container storage area. In some embodiments, the unloading conveyor can be disposed on a first side of the delivery unit, and a second side of the delivery unit (e.g. opposite the first side) can be configured to allow access for loading and unloading containers on the support structures (e.g. second side has open space in proximity to at least the support structures, for example allowing space for forklift operations, e.g. for moving containers with respect to the support structures on the delivery unit).

Some embodiments may further comprise disposing one or more container full of proppant on the delivery unit (e.g. on corresponding support stands/structures), wherein the one or more container is configured to discharge proppant onto the delivery conveyor. Some embodiments may further comprise disposing one or more empty container at the refilling station(s). Some embodiments may comprise disposing a plurality of containers full of proppant at the buffer container storage station (e.g. at a first portion) and/or disposing a plurality of empty containers at the buffer container storage station (e.g. a second portion). In some embodiments, installing a buffer container storage area can comprise installing a pad and disposing supports on the pad, wherein the supports are configured to hold the containers above the ground (e.g. providing clearance for their discharge gates and/or providing easy access for the forklift). Some embodiments may further comprise installing sensors configured to detect the presence of containers and/or the fill level of proppant in the containers.

In some embodiments, installing one or more (e.g. two or more) refilling stations can comprise installing a pad and disposing supports on the pad, wherein the supports are configured to hold the containers above the ground (e.g. providing clearance for their discharge gates and/or providing easy access for the forklift). Some embodiments may further comprise installing sensors configured to detect the presence of containers and/or fill level of proppant in the containers. In embodiments, the support of the refill station(s) may each be similar to those of one of the support structure(s) and/or buffer container storage station. In some embodiments, installing an unloading conveyor can comprise positioning a receiving end distal to the delivery unit and a discharge end proximal to the delivery unit (e.g. with the discharge end configured to discharge into the surge hopper), and providing ramps at the receiving end configured to allow a belly-dump truck to drive over the receiving end (e.g. without damage) for positioning of the belly-dump truck for discharge of proppant onto the receiving end of the unloading conveyor. The discharge end is typically higher (elevated) compared to the receiving end. In some embodiments, the unloading conveyor comprises an offloading portion and a radial portion, and the method can further comprise configuring the radial portion to rotate/pivot the discharge end (e.g. along a radial arc), and configuring the offloading portion to feed proppant from the receiving end to the radial portion.

Some embodiments may further comprise providing a forklift. The forklift can be configured to move containers (e.g. from the refill station to the buffer container storage area/station or to a support structure of the delivery unit configured to hold a full container of proppant for discharge onto the delivery conveyor, from the buffer container storage area/station to the support structure, from the support structure to the buffer container storage area/station, and/or from the support structure to the refill station). In some embodiments, the forklift can be disposed between and/or can operate between the buffer container storage area/station and the blender (e.g. an area of operation of the forklift can be disposed between the buffer container storage area and the blender). In some embodiments, the delivery unit can be disposed between the belly-dump delivery truck/unloading conveyor and the forklift (e.g. the area of operation of the forklift). In some embodiments, only one forklift may operate at the site and/or in the area of operation for forklift at a time (e.g. there may only be one forklift at the site, or there may be two forklifts, but only one operates at any given time (for example with the second forklift held in reserve in case of maintenance or malfunction)).

Some embodiments may further comprise providing a belly-dump truck having proppant. Providing a belly-dump truck may comprise filling the belly-dump truck with proppant (e.g. at a location remote from the site), driving the full belly-dump truck on roads (e.g. with the belly-dump truck not exceeding DOT regulations), and positioning the belly-dump truck with respect to the receiving end of the unloading conveyor (e.g. with the clamshell gate disposed over the receiving end). Typically, the unloading conveyor can be disposed between the belly-dump truck and the delivery unit (e.g. extending therebetween to feed proppant to the delivery unit). In some embodiments, the unloading conveyor comprises a receiving end configured to receive proppant from the belly-dump truck and a discharge end configured to discharge proppant alternately/switchably/selectively to the surge hopper and/or the refill station(s). In some embodiments, the receiving end comprises a ramp, and the method may further comprise driving the belly-dump truck over the ramp to position for discharge of proppant from the belly-dump truck onto the receiving end of the unloading conveyor. In some embodiments, the unloading conveyor can be configured to preferably discharge proppant to the surge hopper, but to discharge proppant in excess of a capacity of the surge hopper to the refill station(s). The proppant delivery system being installed may comprise one of the systems described herein.

Disclosed embodiments also include methods of servicing a wellbore using any of the systems disclosed herein. For example, a method may comprise: directing (e.g. dumping) proppant from a belly-dump truck (or other proppant transport vehicle) onto a receiving end of an unloading conveyor; transporting proppant, using the unloading conveyor, to a surge hopper of a (mobile) delivery unit; transporting/feeding proppant from the surge hopper to a blender inlet/hopper using a transport conveyor of the delivery unit; and responsive to the surge hopper being full (e.g. reaching capacity), switching proppant delivery to a refilling station having an empty container. There are various ways in which proppant delivery can be switched between the surge hopper and the refill station, and all such embodiments are included within this disclosure.

For example, in an embodiment, switching proppant delivery to a refilling station can comprise moving a discharge end of the unloading conveyor to a refilling station having an empty container and transporting proppant to the empty container (at the refill station) using the unloading conveyor. Some method embodiments may comprise, responsive to the surge hopper no longer being full (e.g. having available capacity), moving the discharge end of the unloading conveyor back to the surge hopper of the delivery unit (e.g. so that the discharge end is disposed above the surge hopper). Some method embodiments may comprise, responsive to the empty container becoming full (e.g. reaching its capacity), moving the discharge end of the unloading conveyor to another refill station having another empty container. Some embodiments may further comprise moving the full container from the (first) refill station to a buffer storage station, and moving another empty container (e.g. from the buffer storage station, for example the from the second portion thereof, or from the delivery unit) to the (first) refill station.

Some method embodiments may also comprise, responsive to the surge hopper emptying (e.g. having no proppant therein), directing (e.g. gravity-fee dropping) proppant from a first full container disposed on the delivery unit (e.g. on a support structure disposed above the delivery conveyor) onto the delivery conveyor and transporting/feeding proppant from the first full container to the blender inlet/hopper using the delivery conveyor (e.g. to maintain proppant feed to the blender, even when the surge hopper runs empty, for example due to trucking delays). In some embodiments, the proppant feed to the blender inlet can be maintained at substantially continuous and/or constant rate (e.g. even when the surge hopper empties).

Some method embodiments may comprise, responsive to the first full container on the delivery unit emptying (e.g. having no proppant therein), removing the (now) empty container from the transport unit and moving it to the buffer storage station (e.g. the second portion) or to the refilling station, and moving a new full container from the buffer storage station (e.g. from a first portion) to the delivery unit (e.g. the support structure). Some method embodiments may comprise, responsive to the first full container on the delivery unit emptying (e.g. having no proppant therein), directing (e.g. gravity-feed dropping) proppant from a second full container disposed on the delivery unit (e.g. on a support structure disposed above the delivery conveyor) onto the delivery conveyor and transporting/feeding proppant from the second full container to the blender inlet/hopper using the delivery conveyor (e.g. to maintain proppant feed to the blender, even when both the surge hopper and the first container run empty, for example due to trucking delays). In some embodiments, the proppant feed to the blender inlet can be maintained at substantially continuous and/or constant rate (e.g. even when the surge hopper and the first container empties).

Some embodiments may further comprise positioning the belly-dump truck for proppant drop (gravity feed) onto the receiving end of the unloading conveyor. Positioning the belly-dump truck for proppant drop can comprise driving the belly-dump truck over a ramp spanning the receiving end of the unloading conveyor. In some embodiments, the belly-dump truck can have 50,000 to 54,000 pounds of proppant, while a combined weight of the truck and the proppant is less than DOT standards (e.g. allowing transport over public roads). Some embodiments can further comprise positioning the delivery end of the unloading conveyor above the surge hopper of the delivery unit. Some embodiments can further comprise metering the feed of proppant into the blender inlet/hopper by varying the speed of the delivery conveyor. Some method embodiments can further comprise maintaining substantially continuous supply of proppant to the blender inlet/hopper (e.g. drawing from either the surge hopper or the full containers).

In some embodiments, moving the discharge end of the unloading conveyor can be motorized (e.g. using motor and wheels on the unloading conveyor for movement along a radial arc or by extending the unloading conveyor telescopically). In some embodiments, moving containers (e.g. either from the refill station to the buffer storage station, from the buffer storage station to the refill station, from the delivery unit to the buffer storage station, and/or from the buffer storage station to the delivery unit) can be by forklift (or other mechanical movement means, such as a crane). In embodiments, only a single forklift may be used (and available) at the site and/or for the method.

Some method embodiments can further comprise detecting the presence of container at the refill station and/or on the delivery unit (e.g. support structure) and/or detecting the amount of proppant in container (e.g. fill level, full, empty). For example, this may be done using a load cell or other sensor. In some embodiments, movement of the discharge end of the offloading conveyor can be automated (e.g. based on sensor readings and/or using a control system, which for example may operate the motor based on the sensor information).

Some method embodiments can further comprise using the surge hopper and one or both of the full containers on the delivery unit to provide multiple proppant types to the blender (e.g. main/primary proppant plus secondary proppant). For example, the surge hopper may have a first type of proppant (e.g. the primary proppant) and the containers may have a second type of proppant. In some embodiments, the two or more containers may have different types of proppant, either with one having the same type of proppant as the surge hopper or with the surge hopper and each of the containers having different proppant (e.g. allowing three different types of proppant to be mixed, for example). Typically, only one type of proppant may be provided to the delivery conveyor at a time (e.g. serial provision of multiple sand types). Some embodiments further comprise blending the proppant in the blender with liquid (e.g. water) (e.g. to form treatment fluid, such as fracturing fluid) and directing the output from the blender to a well. Some method embodiments further comprise performing (e.g. fracking or other wellbore servicing) treatment on the well (e.g. hydrocarbon well).

In some embodiments (e.g. see FIG. 1), the unloading conveyor is configured to pivot/rotate to move the discharge end along a radial arc, and moving a discharge end of the unloading conveyor to a refilling station can comprise rotating/pivoting the unloading conveyor. For example, the refilling station(s) and the surge hopper can be disposed/located on the radial arc, such that pivoting/rotating can move the discharge end of the unloading conveyor between stations (e.g. positioning the discharge end over the refill station). Similarly, moving the discharge end of the unloading conveyor back to the surge hopper of the delivery unit can comprise rotating/pivoting the unloading conveyor (e.g. to move the position of the discharge end from the refilling station to the surge hopper). Also, moving the discharge end of the unloading conveyor to another refill station having another empty container can comprise rotating/pivoting the unloading conveyor (with the second refill station also on the radial arc, and rotating acting to position the discharge end over the second refill station).

In some embodiments (e.g. see FIG. 2), the unloading conveyor is further configured for telescoping (e.g. having a retracted and an extended position, in addition to being rotatable), and the method can further comprise moving (e.g. rotating and extending) the discharge end of the unloading unit to the blender inlet (e.g. positioned above the blender inlet, e.g. for direct feed). For example, the blender may not be disposed on the radial arc, and moving may further comprise rotating the unloading conveyor and extending the unloading conveyor (e.g. to position the discharge end over the blender inlet). Some embodiments may further comprise metering proppant into the blender inlet by controlling the variable speed of the unloading conveyor.

In some embodiments (e.g. see FIG. 3), the blender inlet may also be disposed on the radial arc (e.g. along with the surge hopper and refill station), and the method may further comprise moving/rotating the discharge end of the unloading unit to the blender inlet (e.g. positioned above the blender inlet, e.g. for direct feed). Since the blender inlet is located on the radial arc, moving the discharge end of the unloading conveyor for direct discharge to the blender inlet may not require extension or retraction-for example, the length of the unloading conveyor may be fixed/constant, and the only movement may be rotation/pivoting). Some embodiments may further comprise metering proppant into the blender inlet by controlling the variable speed of the unloading conveyor.

In some embodiments (e.g. see FIG. 4), the unloading conveyor is configured for telescoping (e.g. having a retracted and an extended position), and moving a discharge end of the unloading conveyor to a refilling station can comprise extending the telescoping unloading conveyor (e.g. to its extended position). In some embodiments, this extension movement may occur without rotation (e.g. purely linear movement of the discharge end of the unloading conveyor to be positioned over the refill station). In some embodiments, the refilling station(s) and the surge hopper are aligned with the unloading conveyor (e.g. such that telescoping alone can be sufficient to reposition the discharge end between stations) and/or the refilling stations are disposed beside the delivery unit, opposite the belly-dump truck and/or unloading conveyor. In some embodiments, moving the discharge end of the unloading conveyor back to the surge hopper of the delivery unit can comprise retracting the telescoping unloading conveyor (e.g. to its retracted position) (e.g. to position the discharge end over the surge hopper of the primary station). In some embodiments, moving the discharge end of the unloading conveyor to another refill station having another empty container can comprise extending or retracting (e.g. depending on the relative location of the first and second refill stations) the telescoping unloading conveyor (e.g. to position the discharge end over the second refill station). In some embodiments, this may occur without rotation/pivoting (e.g. with the two refill stations in-line with the unload conveyor (e.g. disposed approximately in-line with the longitudinal centerline of the unloading conveyor).

In some embodiments (e.g. see FIG. 5), the unloading conveyor can be configured for telescoping (e.g. having a retracted and an extended position) and rotating/pivoting, and moving a discharge end of the unloading conveyor to a refilling station further comprises, in addition to rotating along the radial arc, extending the telescoping unloading conveyor (e.g. to its extended position). In other words, moving the discharge end between stations may include both rotating and extending of the unloading conveyor. In some embodiments, the refill station can be disposed behind (e.g. adjacent to) a rear of the delivery unit. In some embodiments, moving the discharge end of the unloading conveyor back to the surge hopper of the delivery unit can comprise rotating and retracting the unloading conveyor. In some embodiments, the second refill station can be positioned in line behind the delivery unit and the first refill station, and moving the discharge end of the unloading conveyor to another refill station having another empty container can comprise rotating and extending or retracting the telescoping unloading conveyor (e.g. with the amount of rotation and extension or retraction depending on the specific location of the stations, for example relative to each other).

In some embodiments (e.g. see FIG. 6), the unloading conveyor can be configured for telescoping (e.g. having a retracted and an extended position), in addition to rotating/pivoting, and moving the discharge end of the unloading conveyor to another refill station having another empty container can comprise rotating and extending or retracting the telescoping unloading conveyor (e.g. to move the discharge end along concentric radial arcs). For example, the refill stations can be disposed on concentric radial arcs (e.g. of the unloading conveyor), and rotating and telescoping of the unloading conveyer may allow for proppant to be fed to containers at refill stations disposed on the concentric radial arcs. Some embodiments may comprise using the unloading conveyor to fill empty containers disposed at refill stations which are located on concentric arcs (e.g. with a plurality of refill stations disposed on each of the concentric arcs). In some embodiments, using a combination of rotation/pivoting and telescoping can allow for more complex site configurations, for example allowing for a plurality of refill stations to be located at various positions relative to the delivery unit while still being capable of being filled by the unloading conveyor (e.g. if the surge hopper is at capacity). Persons of skill will appreciate the site planning flexibility that this can provide.

In some embodiments (e.g. see FIG. 7), there may be no movement of the discharge end of the unloading conveyor in order to switch proppant delivery to refill stations. Instead, an overflow approach may be used. For example, a refill station can be disposed adjacent to and/or in proximity to the surge hopper, and the surge hopper can be configured to direct overflow of proppant (e.g. proppant in excess of the capacity of the surge hopper) from the surge hopper to the refill station (e.g. using an overflow element). In such embodiments, switching proppant delivery to a refilling station can comprise directing overflow of proppant from the surge hopper (e.g. excess proppant beyond capacity) to the refill station. For example, directing can comprise opening a valve or gate for gravity feed of proppant from the surge hopper to the empty container at the refill station (e.g. via the overflow element). In some embodiments, there may be a plurality of refill stations located in proximity to and/or disposed adjacent to the surge hopper of delivery unit, and the overflow element may be repositioned (e.g. by pivoting rotation and/or telescoping, for example of a chute or nozzle of the overflow element) and/or reconfigured (e.g. opening and closing of gates to direct proppant flow between various chutes/nozzles) to direct proppant flow to either of the refill stations. In some embodiment, when the first refill station is at capacity (and the surge hopper is also at capacity), the overflow element may be repositioned or reconfigured to direct proppant flow from the surge hopper to the second refill station (e.g. switching/alternating overflow proppant direction from the first to the second refill station).

In embodiments, proppant from the belly-dump truck and/or unloading conveyor may at all times flow into the surge hopper of the delivery unit, and the flow of overflow proppant to the refill station(s) may be sufficient to avoid exceeding capacity of the surge hopper (e.g. with the flow out from the surge hopper to the refill statin(s) being equal to or greater than the flow of proppant into the surge hopper form the unloading conveyor and/or belly-dump truck). In some embodiments, the unloading conveyor discharge end may remain in position above the surge hopper throughout discharge (e.g. neither rotating or telescoping). In some embodiments, the containers at the refill station(s) may be located below the overflow element (e.g. chute or nozzle), such that gravity feed of proppant can direct proppant to the refill station(s) upon opening of the corresponding gate/valve.

In some embodiments, the first refill station would be filled to capacity before switching/alternating to direct proppant flow to the second refill station. Then, the full container can be removed from the first refill station and replaced with another empty container. In some embodiments, once the surge hopper has capacity again, the overflow of proppant would cease, with all proppant remaining in the surge hopper (and no proppant being directed to the refill station(s)). For example, the overflow element would be closed (e.g. the gate/nozzle would be closed, for example by an actuator) so long as there is capacity available in the surge hopper (with the refill station(s) only being used as a stand-by for overflow when needed). In some embodiments, the controller may automatically operate the gate/nozzle and/or the unloading conveyor, for example based on the sensed information.

Disclosed system and method embodiments may have advantages over standard direct feed systems and standard containerized systems, for example allowing for offloading of proppant in trucks directly to the system feeding the blender (e.g. without the need for container loading), while also allowing for intermediate storage on site of excess capacity and/or use or stored capacity to address shortages (e.g. due to delivery delays). This can prevent trucks from having to wait idly until there is capacity in the primary proppant storage, making more efficient use of the supply chain. Additionally, the containers of the present system can be used to provide substantially continuous proppant delivery to the blender, despite any trucking delays. Thus, the system can help to smooth out proppant delivery issues, providing better and more efficient management of proppant delivery and helping to provide substantially continuous operations at the wellsite (e.g. improved inventory management). An additional benefit of the disclosed systems may be that it can keep the equipment lower to the ground (e.g. no personnel working at excessive height, for example no more than 20 feet above ground level or personnel always in proximity to the ground, for example compared to traditional silo systems). Additionally, disclosed systems may reduce the number of belts or single point failures, for example compared to traditional systems, providing improved reliability.

Furthermore, the disclosed systems can minimize usage of forklifts (e.g. forklift traffic) on site, since the forklift may not be needed except for occasional movement of containers (e.g. in instances of system disequilibrium). Traditional container systems typically require utilization of a forklift on all proppant delivered to the blender. In some disclosed embodiments, forklift usage may be minimized since direct feed can be used as the primary delivery system for proppant. If proppant supply (e.g. belly-dump truck scheduling) can be appropriately matched to blender needs, then it is possible that no forklift usage may be required. However, in the event that there are trucking delays, the blender may nevertheless be fed using containerized proppant as a back-stop, with the forklift only then having to reposition containers as needed for supply. Consequently, disclosed systems can lower maintenance costs on the forklift (e.g. due to significantly less usage on site), as well as reduce risk of HSE incidents for each delivery. And, if proppant delivery trucking schedules can match proppant delivery schedules for pumping (e.g. blender needs), it is possible that no forklift operations would be needed to deliver proppant to the blender, while also minimizing costs incurred for detention for truck deliveries waiting to unload proppant.

So, disclosed systems may maintain advantages of containerized sand (e.g. with storage of reserves on site, improved inventory management, etc.) while reducing forklift traffic (and accompanying issues) and increasing payload per truck (e.g. since transport of proppant without separate containers can provide more truck capacity for actual proppant load). The use of belly-dump trucks can lead to more proppant payload per truck trip, especially for example with respect to conventional container delivery systems. For example, more of the weight for transport (e.g. DOT approved maximum weight) can be devoted to proppant, since less structural support may be needed for belly-dump trucks (e.g. compared to fully containerized approaches, in which the structure of the containers can account for unusable weight). Some disclosed systems may also allow for multiple sand/proppant types (e.g. with the option for secondary proppant being mixed with primary proppant). Furthermore, the disclosed embodiments may provide for alternate site layouts, which may be more complex and/or more adaptable to specific situations. These and other benefits will be apparent to those skilled in the art field based on the disclosure herein.

### ADDITIONAL DISCLOSURE

The following are non-limiting, specific embodiments in accordance with the present disclosure:

In a first embodiment, a proppant delivery system (e.g. configured to provide proppant to a blender for well services) can comprise: an unloading conveyor (e.g. a moving belt); a delivery unit; and one or more refill station; wherein: the delivery unit comprises a surge hopper (e.g. configured to hold proppant); one or more (e.g. two or more) support structures, each configured to support a portable buffer container (e.g. holding proppant); and a delivery conveyor (e.g. a moving belt) configured to transport/feed proppant from the surge hopper and/or buffer containers (e.g. selectively) to an inlet for the blender (e.g. the inlet may comprise a hopper); each support structures is configured to hold the corresponding buffer container above the delivery conveyor (e.g. with discharge gate located above the delivery conveyor so that when open, proppant in the buffer container is gravity fed onto the delivery conveyor); the unloading conveyor is configured to receive proppant (e.g. dropped via gravity feed from a belly-dump truck) and to transport the proppant (e.g. to the delivery unit, for example to the surge hopper, and/or to the refill station); each refill station is configured to hold an empty buffer container (e.g. for refill); and proppant (e.g. from the belly-dump truck) is selectively/alternately/switchably/interchangeably transported to the surge hopper and/or refill station.

A second embodiment can include the system of the first embodiment, wherein the unloading conveyor comprises a receiving end configured to be positioned under the belly-dump truck (e.g. with a height sufficiently low to fit beneath the belly-dump truck and/or configured to substantially contain the dumped proppant) and a discharge end configured to discharge proppant (e.g. into the surge hopper of the delivery unit and/or into empty buffer containers and/or directly into the blender hopper/inlet (e.g. selectively), depending for example on the specific embodiment/configuration of the system).

A third embodiment can include the system of the first or second embodiment, wherein the delivery unit is configured to be transportable/mobile (e.g. a trailer with wheels and a hitch for attachment to a transport truck).

A fourth embodiment can include the system of any one of the first to third embodiments, wherein the delivery conveyor is disposed below the surge hopper and the buffer containers and is configured to receive proppant therefrom, and wherein the delivery conveyor is configured to feed proppant to the blender inlet/hopper and/or to meter the proppant into the blender (e.g. delivery conveyor is variable speed).

A fifth embodiment can include the system of any one of the first to fourth embodiments, wherein the delivery conveyor forms a floor/bottom of the surge hopper.

A sixth embodiment can include the system of any one of the first to fifth embodiments, wherein the delivery conveyor is curved (e.g. across its width, so that its side edges are elevated above its central portion), to help retain proppant therein (e.g. to keep proppant from falling off the side edges), and wherein the surge hopper further comprises a back, two sides, a front, and an open top; wherein the back and two sides extend upward from the delivery conveyor (e.g. to enclose the delivery conveyor) and the front does not contact the delivery conveyor (e.g. leaving an opening/gap in the front of the surge hopper allowing proppant therein to be carried out by the delivery conveyor).

A seventh embodiment can include the system of any one of the first to sixth embodiment, wherein the surge hopper comprises a primary hopper permanently mounted in place with respect to the delivery conveyor and a removable height/extension portion/sheath configured to removably couple atop the primary hopper to extend the height/volume of the surge hopper.

An eighth embodiment can include the system of any one of the first to seventh embodiments, wherein the open top of the surge hopper is disposed no more than 20 feet (or 15 feet or 10 feet) above the ground/surface and/or receiving end of the unloading conveyor. In some embodiments, the top of the primary hopper may be no more than 20 feet (or 15 feet or 10 feet) above the ground/surface and/or receiving end of the unloading conveyor, and the extension portion may extend additional height. In other embodiments, the entire surge hopper (e.g. including the extension portion) may be no more than 20 feet (or 15 feet or 10 feet) above the ground/surface and/or receiving end of the unloading conveyor.

A ninth embodiment can include the system of any one of the first to eighth embodiments, wherein the surge hopper has a volume greater than a single container-for example a volume of approximately 2-5 containers (e.g. 2-3 containers).

A tenth embodiment can include the system of any one of the first to ninth embodiments, wherein the delivery conveyor, surge hopper, and support structures are mounted on a trailer (e.g. the surge hopper, delivery conveyor, and support structures are integral to the trailer-e.g. not removable, but fixed).

An eleventh embodiment can include the system of any one of the first to tenth embodiments, further comprising a removable buffer container for each support structure, wherein each container is removably disposed on the corresponding support structure and is (e.g. initially) full of proppant (e.g. providing buffer volume of proppant, for example for use if the surge hopper runs out of proppant/empties).

A twelfth embodiment can include the system of any one of the first to eleventh embodiments, wherein the unloading conveyor is disposed on a first side of the delivery unit, and wherein a second side of the delivery unit (e.g. opposite the first side) is configured to allow access (e.g. to the forklift) for loading and unloading containers on the support structures (e.g. second side has open space in proximity to at least the support structures).

A thirteenth embodiment can include the system of any one of the first to twelfth embodiments, wherein the unloading conveyor is configured to be rotatable (e.g. pivotable) between two or more stations/positions, wherein one (e.g. the primary) station is the surge hopper (e.g. with the rotation/pivoting moving the discharge end along a radial arc).

A fourteenth embodiment can include the system of the thirteenth embodiment, wherein a second station of the two or more stations comprises a refill station configured to hold an empty buffer container.

A fifteenth embodiment can include the system of any one of the thirteenth to fourteenth embodiments, wherein the unloading conveyor comprises an offloading portion, having the receiving end, and a radial portion, configured to angle upward to the discharge end and to rotate/pivot to move the discharge end along a radial arc, and wherein both the offloading portion and the radial portion comprise a moving belt configured for transport of proppant.

A sixteenth embodiment can include the system of the fifteenth embodiment, wherein the radial portion comprises a hopper configured to receive proppant from the offloading portion (e.g. at the end proximal to the offloading portion/the opposite end from the discharge end), and wherein the radial portion operates faster than the offloading portion (e.g. belt speed).

A seventeenth embodiment can include the system of any one of the fifteenth to sixteenth embodiments, wherein the radial portion comprises wheels and/or a motor configured to pivot the radial portion along the radial arc and/or between stations (e.g. rotation/pivoting may be motor driven).

An eighteenth embodiment can include the system of any one of the fourteenth to seventeenth embodiments, wherein the secondary station further comprises a second refill station, wherein each refill station is configured to hold an empty buffer container positioned on the radial arc for the unloading conveyor.

A nineteenth embodiment can include the system of any one of the fourteenth to eighteenth embodiments, wherein each refill station comprises a pad (e.g. configured to support the corresponding container), one or more locator elements (e.g. configured to orient the container on the pad), and/or one or more sensors (e.g. configured to detect the presence of a container and/or the fill level of the container, such as a load cell—e.g. sensor configured to indicate the presence/amount of proppant/fill within each container and/or the presence of a corresponding container) (e.g. in some embodiments, each refill station may be similar in structure to the upper surface of the support structures).

A twentieth embodiment can include the system of the nineteenth embodiment, wherein the pad comprises a plurality of supports configured to support the container with its discharge gate above the ground (e.g. provide clearance for the discharge gate), and wherein the load cell is disposed between the supports.

A twenty-first embodiment can include the system of any one of the thirteenth to twentieth embodiments, wherein the unloading conveyor is further configured for telescoping (e.g. as well as rotation/pivot) (e.g. has an extendable length).

A twenty-second embodiment can include the system of the twenty-first embodiment, wherein (in addition to directing proppant to the surge hopper (e.g. primary station) and second station (e.g. refill stations for empty containers)) the unloading conveyor is further configured to discharge proppant to a third station (e.g. directly to the blender, for example directly into the blender inlet/hopper).

A twenty-third embodiment can include the system of the twenty-second embodiment, wherein (to discharge proppant directly to the blender) the unloading conveyor is configured to rotate and telescope (e.g. extend) to place the discharge end at the third station/blender inlet (e.g. for direct discharge into the blender inlet/hopper and/or direct metering of proppant into the blender).

A twenty-fourth embodiment can include the system of any one of the thirteenth to twentieth embodiments, wherein both the blender inlet/hopper and the surge hopper are disposed on the radial arc of the unloading conveyor (e.g. the delivery unit is oriented to place both the blender feed end of the delivery unit and the surge hopper on the radial arc of the unloading conveyor).

A twenty-fifth embodiment can include the system of the twenty-fourth embodiment, wherein (in addition to directing proppant to the primary station (e.g. surge hopper) and second station (e.g. refill stations for empty containers)) the unloading conveyor is further configured to discharge proppant to a third station (directly to the blender, for example directly into the blender inlet/hopper) (e.g. the unloading conveyor is configured to rotate to the third station/blender inlet).

A twenty-sixth embodiment can include the system of any one of the first to twelfth embodiments, wherein the unloading conveyor is configured for telescoping (e.g. extendable length) (e.g. with no rotation/pivoting).

A twenty-seventh embodiment can include the system of the twenty-sixth embodiment, wherein in retracted position, the telescoping unloading conveyor feeds the surge hopper (e.g. with the discharge end positioned over the surge hopper); and in the extended position, the telescoping unloading conveyor feeds empty container(s) at one or more refill stations located beside (e.g. adjacent to) the delivery unit (e.g. on the opposite side from the belly-dump truck and/or unloading conveyor (e.g. with the one or more empty container located in line with the unloading conveyor)).

A twenty-eighth embodiment can include the system of any one of the twenty-sixth to twenty-seventh embodiments, wherein the unloading conveyor is configured to be telescoping between a primary station (e.g. the surge hopper) and a second station (e.g. one or more refill station for refilling of one or more empty containers).

A twenty-ninth embodiment can include the system of the twenty-eighth embodiment, wherein the second station is disposed beside (e.g. adjacent to) the delivery unit, opposite the belly-dump truck and/or unloading conveyor (e.g. the receiving end of the unloading conveyor).

A thirtieth embodiment can include the system of any one of the twenty-eighth to twenty-ninth embodiments, wherein when the unloading conveyor is at the primary station, the discharge end is disposed above the surge hopper; and when the unloading conveyor is at the second station, the discharge end is disposed above a refill station and/or empty container.

A thirty-first embodiment can include the system of any one of the twenty-eighth to thirtieth embodiments, wherein the second station comprises two or more refill stations, each configured to hold an empty container for refill, and wherein the two or more refill stations are in-line with the unloading conveyor (e.g. located side-by-side next to the delivery unit).

A thirty-second embodiment can include the system of any one of the thirteenth to seventeenth embodiments, wherein the unloading conveyor is further configured for telescoping (e.g. as well as rotation/pivot) (e.g. extendable length), and wherein the second station (e.g. refill station(s)) is disposed behind (e.g. adjacent to) a rear of the delivery unit (e.g. distal to the blender feed end of the delivery conveyor), with the delivery unit disposed between the blender and the second station, and wherein the unloading conveyor is configured to rotate and telescope to place the discharge end at the second station (for discharge of proppant for refilling of empty containers).

A thirty-third embodiment can include the system of the thirty-second embodiments, wherein the telescoping unloading conveyor is in retracted position while feeding the surge hopper (e.g. with the discharge end positioned over the surge hopper); and the telescoping unloading conveyor is in extended position (and rotated/pivoted along the arc with respect to the primary station) while feeding empty container(s) located to the rear of the delivery unit (e.g. at the second station).

A thirty-fourth embodiment can include the system of any one of the thirteenth to twentieth embodiments, wherein the unloading conveyor is further configured for telescoping (e.g. as well as rotation/pivot) (e.g. extendable length), and wherein by telescoping, the unloading conveyor is able to move the discharge end through at least two concentric radial arcs.

A thirty-fifth embodiment can include the system of the thirty-fourth embodiment, wherein the refill stations are disposed on the concentric radial arcs of the unloading conveyor (e.g. two or more refill stations can be disposed on each radial arc).

A thirty-sixth embodiment can include the system of any one of the first to twelfth embodiments, wherein: the discharge end of the unloading conveyor is disposed over and/or feeds into the surge hopper; the refill station is disposed adjacent to and/or in proximity to the surge hopper; and the surge hopper further comprises an overflow element (e.g. a valve and/or chute, etc.) configured to direct proppant from the surge hopper to the refill station having an empty container (e.g. when the surge hopper becomes sufficiently full, thereby preventing overflow of the surge hopper with proppant falling uncontained, for example on the ground).

A thirty-seventh embodiment can include the system of the thirty-sixth embodiment, wherein the refill station (e.g. an empty container at the refill station) is disposed beneath/under the overflow element, and wherein the overflow element is configured for gravity feed of proppant from the surge hopper (e.g. in proximity to its open top) to the refill station (e.g. the empty container thereon).

A thirty-eighth embodiment can include the system of any one of the thirty-sixth to thirty-seventh embodiments, further comprising a second refill station disposed adjacent to and/or in proximity to the surge hopper, wherein the first refill station is disposed adjacent the rear of the delivery unit and/or surge hopper (e.g. distal to the discharge end of the delivery conveyor), and the second refill station is disposed adjacent a side of the delivery unit and/or surge hopper opposite the belly-dump truck, the unloading conveyor, and/or the receiving end of the unloading conveyor; and wherein the overflow element is configured to selectively (e.g. switching between) direct proppant from the surge hopper to the first and second refill stations (e.g. with empty containers thereat).

A thirty-ninth embodiment can include the system of any one of the first to thirty-eighth embodiments, further comprising a plurality of buffer containers disposed at a buffer storage station.

A fortieth embodiment can include the system of the thirty-ninth embodiment, wherein the plurality of containers comprises approximately 20-100 (or 50-100 or 40-60) containers, and/or wherein the plurality of containers each hold approximately 40,000 to 45,000 pounds (e.g. 40,000-42,000 pounds) of proppant (e.g. less volume than surge hopper, for example two containers may be needed to hold the volume of proppant in the belly-dump truck).

A forty-first embodiment can include the system of any one of the thirty-ninth to fortieth embodiments, wherein the buffer storage station comprises a pad configured to hold/support the plurality of containers and/or a locator element (e.g. to ensure proper alignment/orientation/placement of the container(s) on the pad).

A forty-second embodiment can include the system of the forty-first embodiments, wherein the pad of the buffer storage station comprises a plurality of supports configured to support each of the plurality of containers with its discharge gate above the ground (e.g. provide clearance for the discharge gate). Some embodiments may also include sensors (e.g. so the available amount of buffer proppant may be determined).

A forty-third embodiment can include the system of any one of the first to forty-second embodiments, further comprising a blender having a blender inlet/hopper, wherein the delivery conveyor is configured to feed the blender inlet/hopper (e.g. by gravity drop of proppant into the top of the blender inlet/hopper) (In some embodiments, the blender may be integral to the delivery unit).

A forty-fourth embodiment can include the system of any one of the first to forty-third embodiments, further comprising a belly-dump (e.g. bottom hopper) truck configured to empty proppant from its underside (e.g. onto the receiving end of the unloading conveyor).

A forty-fifth embodiment can include the system of the forty-fourth embodiment, wherein the belly dump truck is configured to hold/transport approximately 50,000 to 80,000 pounds (e.g. 50,000 to 54,000 pounds or 53,000 to 54,000 pounds) of proppant (e.g. belly dump truck can hold an amount of proppant up to approximately DOT limits).

A forty-sixth embodiment can include the system of any one of the first to forty-fifth embodiments, further comprising a forklift or other mechanism configured to move containers on-site (e.g. from a second portion of the pad to the refill station, from the refill station to a first portion of the pad, from the first portion of the pad to the support structures on the delivery unit, and/or from the support structures on the delivery unit to the refill station and/or second portion of the pad).

In a forty-seventh embodiment, a method of installing a proppant delivery system (e.g. similar to that of any one of the first to forty-sixth embodiments) for wellbore services, can comprise: providing/installing a blender in proximity to the well configured to provide treatment fluid to the well; positioning a mobile delivery unit in proximity to a blender inlet/hopper of the blender, wherein a delivery conveyor of the delivery unit is configured to feed proppant into the blender inlet/hopper; providing/installing a buffer container storage area configured to hold a plurality of buffer containers; providing/installing one or more (e.g. two or more) refilling stations each configured to hold an empty container (e.g. configured to receive proppant in excess of the capacity of the surge hopper); and/or providing/installing an unloading conveyor configured to receive proppant from a belly-dump truck (or other proppant transport vehicle), wherein the unloading conveyor is configured to (e.g. selectively/alternately) provide proppant to a surge hopper of the delivery unit (e.g. configured to feed proppant to the delivery conveyor) and/or to the refill station(s) (e.g. selectively).

A forty-eighth embodiment can include the method of the forty-seventh embodiment, wherein the unloading conveyor is disposed on a first side of the delivery unit, and a second side of the delivery unit (e.g. opposite the first side) is configured to allow access for loading and unloading containers on the support structures (e.g. the second side has open space in proximity to at least the support structures).

A forty-ninth embodiment can include the method of the forty-seventh to forty-eighth embodiments, further comprising providing a forklift, wherein the forklift is configured to move containers (e.g. from the refill station to the buffer container storage area or to a support structure of the delivery unit configured to hold a full container of proppant for discharge onto the delivery conveyor, from the buffer container storage area to the support structure, from the support structure to the buffer container storage area, and/or from the support structure to the refill station).

A fiftieth embodiment can include the method of the forty-ninth embodiment, wherein the forklift is disposed between and/or operates between the buffer container storage area and the blender (e.g. an area of operation of the forklift is disposed between the buffer container storage area and the blender), and wherein the delivery unit is disposed between the belly-dump delivery truck/unloading conveyor and the forklift (e.g. the area of operation of the forklift).

A fifty-first embodiment can include the method of any one or the forty-seventh to fiftieth embodiments, further comprising providing a belly-dump truck having proppant, wherein the unloading conveyor extends between the belly-dump truck and the delivery unit.

A fifty-second embodiment can include the method of the fifty-first embodiment, wherein the unloading conveyor comprises a receiving end configured to receive proppant from the bell-dump truck and a discharge end configured to discharge proppant selectively/alternately/switchably to the surge hopper or the refill station(s).

A fifty-third embodiment can include the method of the fifty-second embodiment, wherein the receiving end comprises a ramp, the method further comprising driving the belly-dump truck over the ramp for positioning for discharge of proppant from the belly-dump truck onto the receiving end of the unloading conveyor.

A fifty-fourth embodiment can include the method of any one of the forty-seventh to fifty-third embodiments, wherein the unloading conveyor is configured to preferably discharge proppant to the surge hopper, but to discharge proppant in excess of a capacity of the surge hopper to the refill station(s).

A fifty-fifth embodiment can include the method of the fifty-fourth embodiment, wherein the delivery unit comprises one or more support structure, each configured to hold a (e.g. full) container (e.g. filled with proppant), the method further comprising disposing a full container on each support structure.

A fifty-sixth embodiment can include the method of the fifty-fifth embodiment, wherein the delivery conveyor is configured to preferably feed proppant to the blender inlet/hopper from the surge hopper, but to feed proppant from the container(s) on the support structures to the blender inlet/hopper responsive to the surge hopper running empty.

A fifty-seventh embodiment can include the method of any one of the forty-seventh to fifty-sixth embodiments, wherein the proppant delivery system comprises one selected from the first to forty-sixth embodiments.

In a fifty-eighth embodiment, a method of servicing a wellbore (e.g. using the system of any one of the first to forty-sixth embodiments) can comprise: directing (e.g. dumping) proppant from a belly-dump truck (or other proppant transport vehicle) onto a receiving end of an unloading conveyor; transporting proppant, using the unloading conveyor, to a surge hopper of a (mobile) delivery unit; transporting/feeding proppant from the surge hopper to a blender inlet/hopper using a transport conveyor of the delivery unit; and/or responsive to the surge hopper being full (e.g. reaching capacity), switching proppant delivery to a refilling station having an empty container.

A fifty-ninth embodiment can include the method of the fifty-eighth embodiment, wherein switching proppant delivery to a refilling station comprises moving a discharge end of the unloading conveyor to the refilling station (e.g. having the empty container) and transporting proppant to the empty container using the unloading conveyor.

A sixtieth embodiment can include the method of the fifty-ninth embodiment, further comprising, responsive to the surge hopper no longer being full (e.g. having available capacity), moving the discharge end of the unloading conveyor back to the surge hopper of the delivery unit (e.g. so that the discharge end is disposed above the surge hopper).

A sixty-first embodiment can include the method of any one of the fifty-ninth to sixtieth embodiments, further comprising, responsive to the empty container (e.g. at the refill station) becoming full (e.g. reaching its capacity), moving the discharge end of the unloading conveyor to another refill station having another empty container.

A sixty-second embodiment can include the method of the sixty-first embodiment, further comprising moving the full container from the (first) refill station to a buffer storage station, and moving another empty container (e.g. from the buffer storage station) to the (first) refill station.

A sixty-third embodiment can include the method of any one of the fifty-eighth to sixty-second embodiments, further comprising, responsive to the surge hopper emptying (e.g. having no proppant therein), directing (e.g. gravity-feed dropping) proppant from a first full container disposed on the delivery unit (e.g. on a support structure disposed above the delivery conveyor) onto the delivery conveyor and transporting/feeding proppant from the first full container to the blender inlet/hopper using the delivery conveyor (e.g. to maintain approximately consistent proppant feed to the blender, even when the surge hopper runs empty, for example due to trucking delays).

A sixty-fourth embodiment can include the method of the sixty-third embodiment, further comprising, responsive to the first full container on the delivery unit emptying (e.g. having no proppant therein), removing the (now) empty container from the transport unit and moving it to the buffer storage station or to the refilling station, and moving a new full container from the buffer storage station to the delivery unit (e.g. the support structure).

A sixty-fifth embodiment can include the method of the sixty-third or sixty-fourth embodiments, further comprising, responsive to the first full container on the delivery unit emptying (e.g. having no proppant therein), directing (e.g. gravity-feed dropping) proppant from a second full container disposed on the delivery unit (e.g. on a second support structure disposed above the delivery conveyor) onto the delivery conveyor and transporting/feeding proppant from the second full container to the blender inlet/hopper using the delivery conveyor (e.g. to maintain approximately consistent proppant feed to the blender, even when both the surge hopper and the first container run empty, for example due to trucking delays).

A sixty-sixth embodiment can include the method of any one of the fifty-eighth to sixty-fifth embodiments, further comprising positioning the belly-dump truck for proppant drop (gravity feed) onto the receiving end of the unloading conveyor.

A sixty-seventh embodiment can include the method of one of the sixty-second or sixty-fourth embodiments, wherein moving containers (e.g. either from the refill station to the buffer storage station, from the buffer storage station to the refill station, from the delivery unit to the buffer storage station, and/or from the buffer storage station to the delivery unit) is by forklift (or other mechanical movement means, such as a crane).

A sixty-eighth embodiment can include the method of any one of the fifty-eighth to sixty-seventh embodiments, further comprising blending the proppant in the blender with liquid (e.g. water) (e.g. to form treatment fluid, such as fracturing fluid) and directing the output (e.g. treatment fluid) from the blender to a well.

A sixty-ninth embodiment can include the method of the sixty-eighth embodiment, further comprising performing (e.g. fracing or other wellbore servicing) treatment on the well (e.g. hydrocarbon well).

A seventieth embodiment can include the method of any one of the fifty-ninth to sixty-ninth embodiments, wherein the unloading conveyor is configured to pivot/rotate to move the discharge end along a radial arc, wherein moving a discharge end of the unloading conveyor to a refilling station comprises rotating/pivoting the unloading conveyor, wherein the refilling station(s) and the surge hopper are disposed/located on the radial arc.

A seventy-first embodiment can include the method of the seventieth embodiment, wherein moving the discharge end of the unloading conveyor back to the surge hopper of the delivery unit comprises rotating/pivoting the unloading conveyor (e.g. to move the position of the discharge end from the refilling station to the surge hopper).

A seventy-second embodiment can include the method of any one of the seventieth to seventy-first embodiments, wherein moving the discharge end of the unloading conveyor to another refill station having another empty container comprises rotating/pivoting the unloading conveyor (with the second refill station also on the radial arc).

A seventy-third embodiment can include the method of an one of the seventieth to seventy-second embodiments, wherein the unloading conveyor is further configured for telescoping (e.g. having a retracted and an extended position), further comprising moving (e.g. rotating and extending) the discharge end of the unloading unit to the blender inlet/hopper (e.g. positioned above the blender inlet/hopper) (e.g. for direct feed of the blender), and wherein the blender is not disposed on the radial arc, and wherein moving further comprises rotating the unloading conveyor and extending the unloading conveyor.

A seventy-fourth embodiment can include the method of any one of the seventieth to seventy-second embodiments, wherein the blender inlet is also disposed on the radial arc, further comprising moving/rotating the discharge end of the unloading unit to the blender inlet (e.g. positioned above the blender inlet) (e.g. for direct feed).

A seventy-fifth embodiment can include the method of any one of the fifty-ninth to sixty-ninth embodiments, wherein the unloading conveyor is configured for telescoping (e.g. having a retracted and an extended position), wherein moving a discharge end of the unloading conveyor to a refilling station comprises extending the telescoping unloading conveyor (e.g. to its extended position), wherein the refilling station(s) and the surge hopper are aligned with the unloading conveyor and/or wherein the refilling stations are disposed beside the delivery unit, opposite the belly-dump truck and/or unloading conveyor.

A seventy-sixth embodiment can include the method of the seventy-fifth embodiment, wherein moving the discharge end of the unloading conveyor back to the surge hopper of the delivery unit comprises retracting the telescoping unloading conveyor (e.g. to its retracted position).

A seventy-seventh embodiment can include the method of the seventy-fifth or seventy-sixth embodiments, wherein moving the discharge end of the unloading conveyor to another refill station having another empty container comprises extending or retracting (e.g. depending on the relative location of the first and second refill stations) the telescoping unloading conveyor (e.g. to position the discharge end over the second refill station).

A seventy-eighth embodiment can include the method of any one of the seventieth to seventy-second embodiments, wherein the unloading conveyor is configured for telescoping (e.g. having a retracted and an extended position), and wherein moving a discharge end of the unloading conveyor to a refilling station further comprises extending the telescoping unloading conveyor (e.g. to its extended position) [e.g. both rotating and extending], and wherein the refill station is disposed behind (e.g. adjacent to) a rear of the delivery unit.

A seventy-ninth embodiment can include the method of the seventy-eighth embodiment, wherein moving the discharge end of the unloading conveyor back to the surge hopper of the delivery unit comprises rotating and retracting the unloading conveyor.

An eightieth embodiment can include the method of the seventy-eighth or seventy-ninth embodiments, wherein a second refill station is positioned in line behind the delivery unit and the first refill station, and wherein moving the discharge end of the unloading conveyor to another refill station having another empty container comprises rotating and extending or retracting the telescoping unloading conveyor.

An eighty-first embodiment can include the method of any one of the seventieth to seventy-second embodiments, wherein the unloading conveyor is configured for telescoping (e.g. having a retracted and an extended position), and wherein moving the discharge end of the unloading conveyor to another refill station having another empty container comprises rotating and extending or retracting the telescoping unloading conveyor, and wherein the refill stations are disposed on concentric radial arcs.

An eighty-second embodiment can include the method of the fifty-eighth embodiment, wherein a refill station is disposed adjacent to and/or in proximity to the surge hopper, and the surge hopper is configured to direct overflow (e.g. proppant in excess of its capacity) from the surge hopper to the refill station, wherein switching proppant delivery to a refilling station comprises directing overflow of proppant from the surge hopper (e.g. excess beyond capacity) to the refill station.

An eighty-third embodiment can include the method of the eighty-second embodiment, wherein directing overflow comprises opening a valve or gate for gravity feed of proppant from the surge hopper to the empty container at the refill station (e.g. with the empty container at the refill station located beneath the gravity feed (e.g. chute)).

An eighty-fourth embodiment can include the method of any one of the fifty-eighth to eighty-third embodiments, further comprising blending the proppant in the blender with liquid (e.g. water) (e.g. to form fracturing fluid) and directing the output from the blender (e.g. fracturing fluid) to a well.

An eighty-fifth embodiment can include the method of the eighty-fourth embodiment, further comprising performing (e.g. fracking or other wellbore servicing) treatment on the well (e.g. hydrocarbon well).

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A proppant delivery system configured to provide proppant to a blender for well services, comprising:
an unloading conveyor;
a delivery unit; and
one or more refill station;
wherein:
the delivery unit comprises a surge hopper configured to hold proppant; one or more support structure, each configured to support a portable buffer container; and a delivery conveyor configured to feed proppant from the surge hopper and/or the one or more buffer container to an inlet of the blender;
each support structures is configured to hold the corresponding buffer container above the delivery conveyor;
the unloading conveyor is configured to receive proppant from a proppant transport vehicle and to transport the proppant therefrom;
each refill station is configured to hold an empty buffer container; and
proppant from the proppant transport vehicle is selectively transported to the surge hopper and/or refill station.

2. The proppant delivery system of claim 1, wherein the proppant transport vehicle comprises a belly-dump truck, and wherein the unloading conveyor comprises a receiving end configured to be positioned under the belly-dump truck and a discharge end configured to discharge proppant.

3. The proppant delivery system of claim 2, wherein the unloading conveyor is configured to be rotatable between two or more stations, with rotation moving the discharge end along a radial arc; wherein a first station of the two or more stations comprises the surge hopper; and wherein a second station of the two or more stations comprises one of the one or more refill station.

4. The proppant delivery system of claim 3, wherein the second station further comprises a second refill station, wherein each refill station is configured to hold an empty buffer container positioned on the radial arc for the unloading conveyor.

5. The proppant delivery system of claim 3, wherein the unloading conveyor is further configured for telescoping, wherein the unloading conveyor is further configured to discharge proppant to a third station, with the discharge end discharging proppant directly into the blender inlet.

6. The proppant delivery system of claim 3, wherein both the blender inlet and the surge hopper are disposed on the radial arc of the unloading conveyor, wherein the unloading conveyor is further configured to discharge proppant to a third station, with the discharge end discharging proppant directly into the blender inlet.

7. The proppant delivery system of claim 2, wherein the unloading conveyor is configured for telescoping between a retracted and an extended position; wherein in the retracted position, the telescoping unloading conveyor feeds the surge hopper; and wherein in the extended position, the telescoping unloading conveyor feeds the corresponding empty container at the one or more refill stations, which are located adjacent to the delivery unit on the opposite side from the proppant transport vehicle.

8. The proppant delivery system of claim 3, wherein the unloading conveyor is further configured for telescoping, and wherein the second station is disposed behind a rear of the delivery unit, with the delivery unit disposed between the blender and the second station; and wherein the unloading conveyor is configured to rotate and telescope to place the discharge end at the second station.

9. The proppant delivery system of claim 3, wherein the unloading conveyor is further configured for telescoping; wherein by telescoping, the unloading conveyor is able to move the discharge end through at least two concentric radial arcs; and wherein two or more refill stations can be disposed on each of the concentric radial arcs.

10. The proppant delivery system of claim 2, wherein:
the discharge end of the unloading conveyor discharges into the surge hopper;
the refill station is disposed in proximity and adjacent to the surge hopper;
the surge hopper further comprises an overflow element configured to direct proppant from the surge hopper to the refill station;
the refill station is disposed beneath the overflow element; and
the overflow element is configured for gravity feed of proppant from the surge hopper to the refill station.

11. A method of installing a proppant delivery system for wellbore services, comprising:
providing a blender in proximity to a well configured to provide treatment fluid to the well;
positioning a mobile delivery unit in proximity to a blender inlet of the blender, wherein a delivery conveyor of the delivery unit is configured to feed proppant into the blender inlet;
providing a buffer container storage area configured to hold a plurality of buffer containers;
providing one or more refill stations each configured to hold an empty container; and
providing an unloading conveyor configured to receive proppant from a proppant transport vehicle, wherein the unloading conveyor is configured to provide proppant to a surge hopper of the delivery unit and/or to the one or more refill stations.

12. A method of servicing a wellbore, comprising:
directing proppant from a proppant transport vehicle onto a receiving end of an unloading conveyor;
transporting proppant, using the unloading conveyor, to a surge hopper of a mobile delivery unit;
feeding proppant from the surge hopper to a blender inlet using a transport conveyor of the delivery unit; and
responsive to the surge hopper reaching capacity, switching proppant delivery to a refill station having an empty container.

13. The method of claim 12, wherein switching proppant delivery to a refilling station comprises moving a discharge end of the unloading conveyor to the refill station and transporting proppant to the empty container using the unloading conveyor.

14. The method of claim 13, further comprising, responsive to the surge hopper having available capacity, moving the discharge end of the unloading conveyor back to the surge hopper of the delivery unit.

15. The method of claim 13, further comprising, responsive to the empty container at the refill station reaching capacity, moving the discharge end of the unloading conveyor to another refill station having another empty container.

16. The method of claim 15, further comprising moving the full container from the first refill station to a buffer storage station, and moving another empty container to the first refill station.

17. The method of claim 12, further comprising, responsive to the surge hopper emptying, directing proppant from a first full container disposed on the delivery unit onto the delivery conveyor and feeding proppant from the first full container to the blender inlet using the delivery conveyor.

18. The method of claim 17, further comprising, responsive to the first full container on the delivery unit emptying, removing the container from the transport unit and moving it to the buffer storage station or to the refill station, and moving a new full container from the buffer storage station to the delivery unit.

19. The method of claim 17, further comprising, responsive to the first full container on the delivery unit emptying, directing proppant from a second full container disposed on the delivery unit onto the delivery conveyor and feeding proppant from the second full container to the blender inlet using the delivery conveyor.

20. The method of claim 13, wherein the unloading conveyor is configured to rotate to move the discharge end along a radial arc, wherein moving a discharge end of the unloading conveyor to a refill station comprises rotating the unloading conveyor.

21. The method of claim 13, wherein the unloading conveyor is configured for telescoping extension, wherein moving a discharge end of the unloading conveyor to a refill station comprises extending the telescoping unloading conveyor.

22. The method of claim 12, wherein the refill station is disposed adjacent to and in proximity to the surge hopper, and the surge hopper is configured to direct overflow from the surge hopper to the refill station, wherein switching proppant delivery to a refilling station comprises directing overflow of proppant from the surge hopper to the refill station.

23. The system of claim 1, wherein the delivery conveyor comprises two conveyors configured to jointly feed proppant to the inlet of the blender, wherein a first one of the two conveyors is substantially horizontal and is located at a bottom of the surge hopper, and a second one of the two conveyors extends upward from the first conveyor towards the inlet of the blender.
